(19) United States
(12) Patent Application Publication
(10) Pub. No.: US 2019/0073639 A1
(43) Pub. Date: Mar. 7, 2019

(54) TECHNOLOGICAL SYSTEM FOR NAVIGATING EMPLOYMENT BENEFITS

(71) Applicant: Employee Network, Inc., Vestal, NY (US)

(72) Inventor: Gene Raymondi, Vestal, NY (US)

(73) Assignee: Employee Network, Inc., Vestal, NY (US)

(21) Appl. No.: 16/182,717

(22) Filed: Nov. 7, 2018

Related U.S. Application Data
(63) Continuation-in-part of application No. 14/725,408, filed on May 29, 2015.

(51) Int. Cl. G06Q 10/10; G06F 3/0482; G06F 3/0481

(52) U.S. Cl. CPC G06Q 10/1057; G06F 3/04817; G06F 3/0482

(57) ABSTRACT

A technological system for navigating employment benefits. The system has a processor with associated memory storage device and a computer display operatively connected thereto. The system is categorized according to “life event categories.” Users may access the system via an account that is personal and specific to each individual user. The system also has a database of information pertaining to benefits and community resources, with such information being stored in a memory storage device. The information pertaining to benefits and community resources is organized such that when a user accesses the system, the information pertaining to benefits and community resources that is displayed to the user is limited to the benefits and community resources that the user is provided through the user's employment with the user's employer. By accessing the system, the user is able to access information about the availability and utilization of the user's specific employee benefits based on the benefits most relevant to particular life events in a manner that is significantly faster and more efficient than any method of navigating employee benefits that is available to date.

### RELATED PATENT APPLICATION

The present patent application is a continuation-in-part application of copending U.S. patent application Ser. No. 14/725,408 filed May 29, 2015, for SYSTEM FOR COUNSELING EMPLOYEES AND EMPLOYERS WITH REGARD TO EMPLOYER BENEFITS, claims the priority filing date thereof, and hereby incorporates the teachings therein.

### FIELD OF THE INVENTION

This invention relates to systems for navigating employment benefits and, more specifically, to a technological system whereby information regarding the availability and utilization of employment benefits is categorized, stored, and accessed according to life events which might trigger a need to utilize a particular benefit. By using the present invention, a person may quickly and efficiently access large amounts of information regarding available employment benefits and how to utilize employment benefits that are relevant to specific life events.

### BACKGROUND OF THE INVENTION

Many employers provide certain benefits and benefit programs (collectively hereinafter referred to as “benefits”) to their employees as part of their total compensation packages. These benefits may include but are not limited to employer provided personnel benefits, health insurance benefits, disability insurance benefits, life insurance benefits, pension benefits, retirement benefits, stock option programs, profit sharing programs, employee savings accounts and plans, employee credit union accounts and services, employee discount programs, wellness reimbursements, childcare assistance, and various types of leave or other “time off” benefits.

The benefits that employers provide to employees are often numerous and occasion the provision of voluminous amounts of paperwork. For example, federal law requires that employees be provided with a “Summary Plan Description” regarding certain employment benefits. In many cases, Summary Plan Descriptions may consist of multiple separate documents, which can be difficult for average employees to navigate. Similarly, other benefit documents, such as the contract that an employer (or a plan, on behalf of an employer) may enter with a health insurance company, may be as long as one hundred pages. In many cases, an employee may have to request a copy of the contract if needed to examine the benefits available. In such cases, it is often difficult for the average employee to analyze and comprehend such complicated and voluminous contracts.

In many cases, information regarding employee benefits is stored in multiple locations and among multiple custodians. For example, some information regarding health insurance benefits, such as information concerning deductible amounts and basic levels of coverage, may be stored with an employee's human resources department. But other information regarding health insurance benefits, such as which providers are considered “in-network” under a specific health insurance plan, generally must be obtained by contacting the health insurance company.

Information regarding other benefits, such as childcare assistance benefits or wellness reimbursements, may be stored either with an employee's human resources department or with an Employee Assistance Program (EAP) provider (or both). EAP providers are companies that assist employers with the administration of certain employee benefits. Thus, an employee who contacts their human resources department may be redirected to an EAP provider, who may then provide the employee information regarding certain benefits.

In many cases, employers may offer employees so many benefits and the information about the benefits may be so voluminous and dispersed among multiple custodians that employees are often not aware that certain benefits are available or employees do not know how to take advantage of benefits that are available. In other instances, the providers of benefits may be difficult to deal with or may not be easily accessible to the employee. As a result of the foregoing circumstances, which are common across all industries, many employees have to spend significant amounts of time and effort to take advantage of employment benefits that are available to them. In addition, many employees across all industries forego utilizing benefits that are available to them because they do not know the benefits are available or they do not know how to utilize the benefits.

Frustration may result when benefits may be too difficult or complicated to obtain or to gain access to, especially when benefits are not easily understood or when benefits providers are difficult to deal with or to communicate with. Given the fact that most employees seek benefits during the workday, employer time and resources are expended by the employee in attending to benefits matters, usually at the employer's expense. Furthermore, employers incur costs in order to provide benefits. If benefits go unutilized because it is difficult for employees to navigate the benefits, employers are wasting money because they are paying for benefits that their employees never use.

Due to the complicated nature of navigating employment benefits, employees must also be assisted in their efforts to claim or gain access to their benefits and/or to information related thereto. Great amounts of time, money and resources are expended in offering and administering an employee benefits plan or program. Even greater amounts are expended when benefits and/or benefits information is not readily available to or accessible by the employee. This is because employers, benefit plans, and insurance companies must employ individuals to provide information regarding the availability and utilization of benefits when employees seek such information.

In the past, employers had group benefit plans designed to meet the needs of all employees. The problem is that employers have a diverse group of employees having a wide range of different needs. For example, an employer typically has older employees near retirement, middle aged employees with families, single employees, and younger employees that are just starting their careers. As a result, an employer's group benefits plan needs to include a wide variety of insurance and other benefits in order to meet the needs of all of its employees. The old model of group plans is inefficient and often more expensive than necessary. The employer might enroll each employee in the available benefits, even though the employee's needs were not the same.

Increasing benefit costs and reduced available funding have forced employers to shift responsibility for retirement planning and insurance benefits to employees. Employees are offered choices today that allow them to select benefits appropriate to their own situations, but are required to pay for all or part of the costs of the benefits. This introduction of voluntary employee paid benefit plans has resulted in a blurring of the delineation between individual and group products.

As costs have been shifted to employees, employers have endeavored to improve their voluntary benefit packages by incorporating more benefits, including non-traditional insurance benefits and non-insurance benefits. Examples of such benefits that are being offered by employers through payroll deduction today include pre-paid legal services, mortgage refinancing, auto and homeowners insurance, and “pricing club” type benefits such as discount computers.

Computerized systems for administering group benefit plans based on the traditional model are not sufficiently flexible to meet the requirements of the changing benefits marketplace. Such systems maintain information about the insurance products, but not about the employee's benefit plan/package.

Similarly, systems assessing the culture, employee satisfaction, and benefits satisfaction/utilization are not sufficiently flexible to meet the requirements of the changing workforce and benefits marketplace. Such systems generally focus solely on one component, such as culture, while excluding the rest from consideration.

Therefore, there is a need for a system that more efficiently manages the creation, maintenance, and archiving of benefit information. There is a further need for the same aforementioned system to also administer insurance products, non-insurance products, and benefit plans, so that all of an employee's benefit information is stored in the same location. There is also a need for the aforementioned system to be customizable without extensive reprogramming. There is a need for a system that permits the administrator to choose from a wide variety of benefit options in recording the specific employer's benefit package and its employees' choices, without requiring modification of the system's record designs. There is a need for a system that maintains information only at the level at which it is actually needed, allowing the administrator to specify this level differently for different employer groups, for different benefit packages within an employer group, and for different classes of information within a package. There is a need for a system that minimizes the need to modify program code to accommodate modifications or changes to benefit plans. There is a need for a system that links employee life event needs to benefits and community resources that will assist and address these needs. There is a need for a system designed to engage employees with their benefits using gamification and incentives. There is a need for a computer system that permits selection of methods for assessing, measuring, and processing benefits information, performance, and utilization from a wide variety of available methods.

Ideally, the industry needs all of the systems identified in the preceding paragraph to be combined within a single system. This is because, as can be seen from the foregoing, the amount of benefit information that employees must navigate is voluminous and dispersed. Currently, there is no technological solution in the art that enables employees to—by accessing a single system—navigate all information associated with the benefits available to them by virtue of their employment. There is merely a patchwork system of technological and non-technological repositories (and custodians) where information about various benefit is held. Furthermore, as explained above, non-technological solutions that are available for employees to navigate benefit information are inadequate. For example, contacting numerous persons—whether a human resources professional or insurance company employees—is a slow, time consuming process that generally must be undertaken during normal business hours. This is an impractical, difficult, and often unsuccessful process. And when it is successful, the information provided is about a single benefit, not the total scope of benefits available and useful to a person at a particular stage of their life.

### DESCRIPTION OF RELATED ART

U.S. Pat. No. 7,305,347 issued to Joao for “Apparatus and Method for Providing Employee Benefits and/or Employee Benefits Information,” on Dec. 4, 2007, describes a computer-implemented method, including receiving a request or claim for an employee benefit via, on, or over, the Internet, processing the request or claim for an employee benefit with a first processing device or a second processing device accessed via, on, or over, or which operates on or over, the Internet, determining with the first processing device or with the second processing device whether the employee benefit requested in the request or claim for an employee benefit is to be provided, generating a message in response to the request or claim for an employee benefit, and transmitting the message to a communication device associated with at least one of the employee, the benefit beneficiary, an employer, and a benefit administrator, via, on, or over, the Internet.

U.S. Published Patent Application no. 2002/0069077 on application filed by Brophy, et al. for “Computerized System for Customizing and Managing Benefits,” published Jun. 6, 2002, discloses a computer system for administering employee benefits. The computer system comprises a first tier that includes a plurality of users. At least one user is a workstation having a processor and memory. At least one other user is a system processing means. The workstation is configured for inputting rules into the computer system. The rules are for controlling the computer system. The system processing means is configured to generate and execute transactions based upon the rules. A second tier includes memory configured to store the rules. The rules are organized into tables within the memory of the second tier. A third tier includes memory configured to store benefit data. The benefit data is organized into tables in the third tier memory. The benefit data can be manipulated only by the system processing means executing the rule-based transactions.

### SUMMARY OF THE INVENTION

The present invention is a technological system for navigating employment benefits. The system has a processor with associated memory storage device and a computer display operatively connected thereto. The system is categorized according to “life event categories.” Users may access the system via an account that is personal and specific to each individual user. The system also has a database of information pertaining to benefits and community resources, with such information being stored in a memory storage device. The information pertaining to benefits and community resources is organized such that when a user accesses the system, the information pertaining to benefits and community resources that is displayed to the user is limited to the benefits and community resources that the user is provided through the user's employment with the user's employer. By accessing the system, the user is able to access information about the availability and utilization of the user's specific employee benefits based on the benefits most relevant to particular life events in a manner that is significantly faster and more efficient than any method of navigating employee benefits that is available to date.

### BRIEF DESCRIPTION OF THE DRAWINGS

A complete understanding of the present invention may be obtained by reference to the accompanying drawings, when considered in conjunction with the subsequent detailed description, in which:

FIG. 1 is a high level symbolic diagram of common categories of life events available to an employee in accordance with the invention;

FIG. 2 is a screen shot of an administrative control panel;

FIG. 3 is a screen shot of a member portal;

FIGS. 4a through 4ii are screen shots of a mobile application displayed on a cell phone;

FIGS. 5a through 5dd are screen shots of a mobile application displayed on a tablet; and

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

For purposes of this description, the following terms have meanings defined as follows:

Life Events: In the context of this application, the term “life event” (used in any form or in conjunction with any other words [i.e., life event categories]) refers to any occurrence that may happen in a person's life that may trigger the need for the person to utilize employee benefits. The term “life event” as used herein is not synonymous with the term “qualifying event,” as that term is used in the Human Resources and Employee Benefits industries.

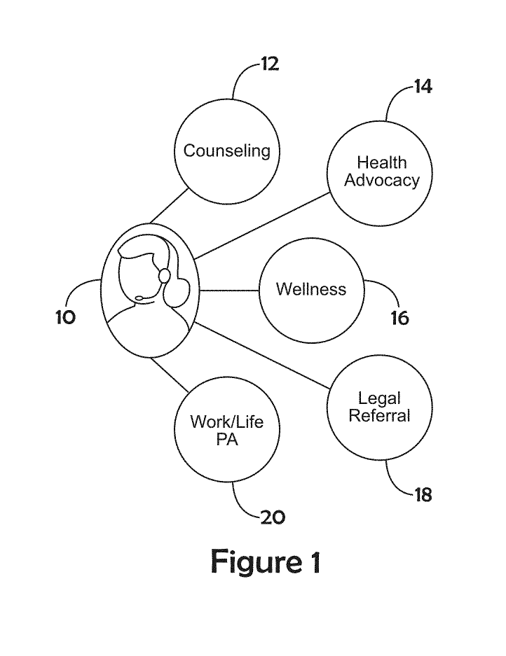

Referring now to FIG. 1, there is shown one example of a diagram of common life experiences according to which employee benefits may be categorized in accordance with the present invention. In the diagram in FIG. 1, the categories of life experiences are broken down at a high, generic level. For example, in the diagram of FIG. 1, an employee 10 may develop a need for information regarding counseling 12, including but not limited to stress management or grief counseling; health advocacy 14, including but not limited to insurance coverage or care coordination; wellness 16, including but not limited to stress management or other participation requirements; legal referrals 18, including but not limited to living wills, estate planning, or testamentary instruments; work/life personal assistant (PA), including but not limited to funeral coordination; and other categories, not shown, but within the scope of the invention.

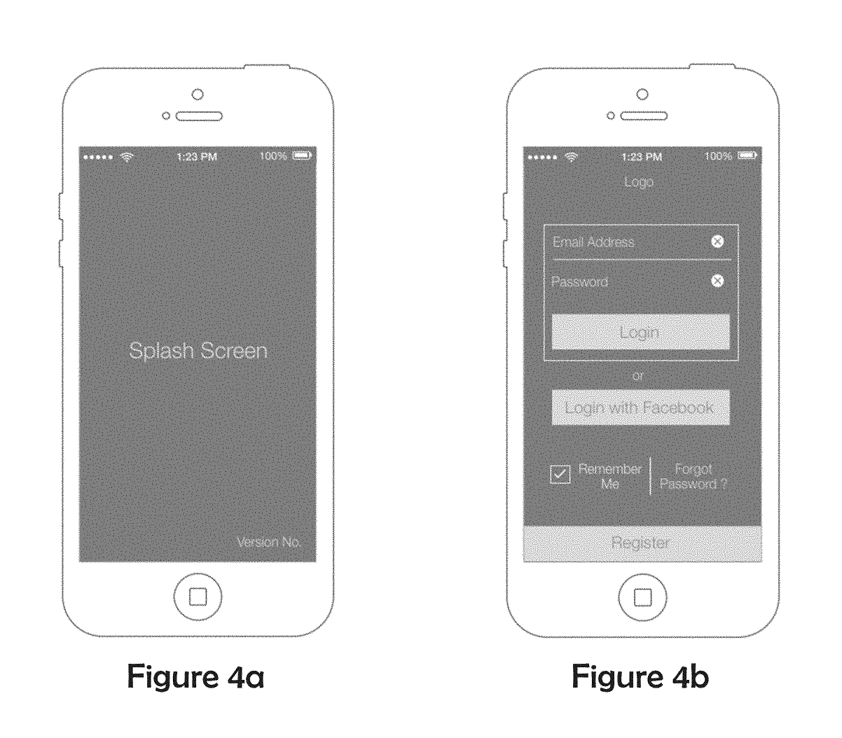

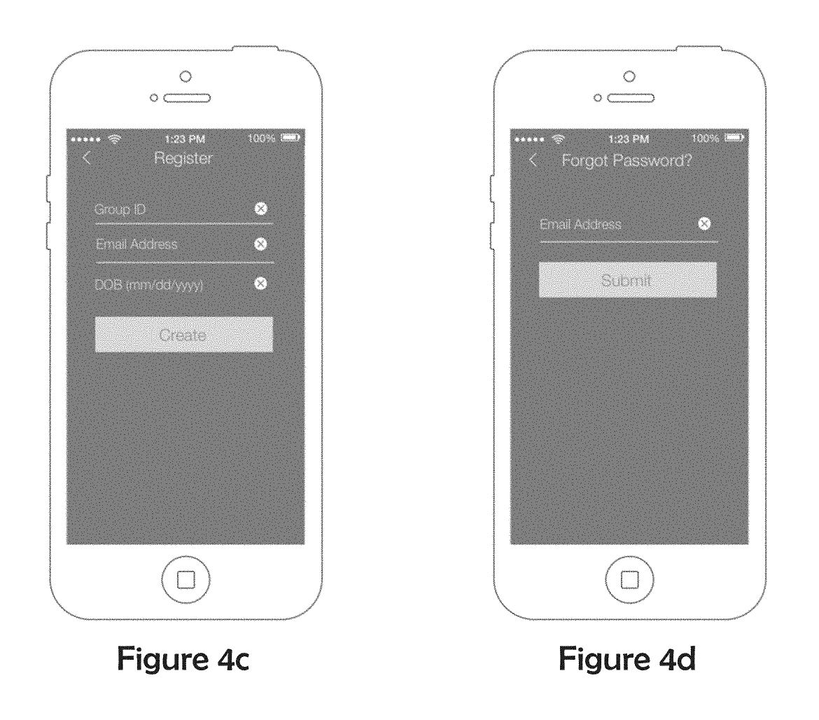

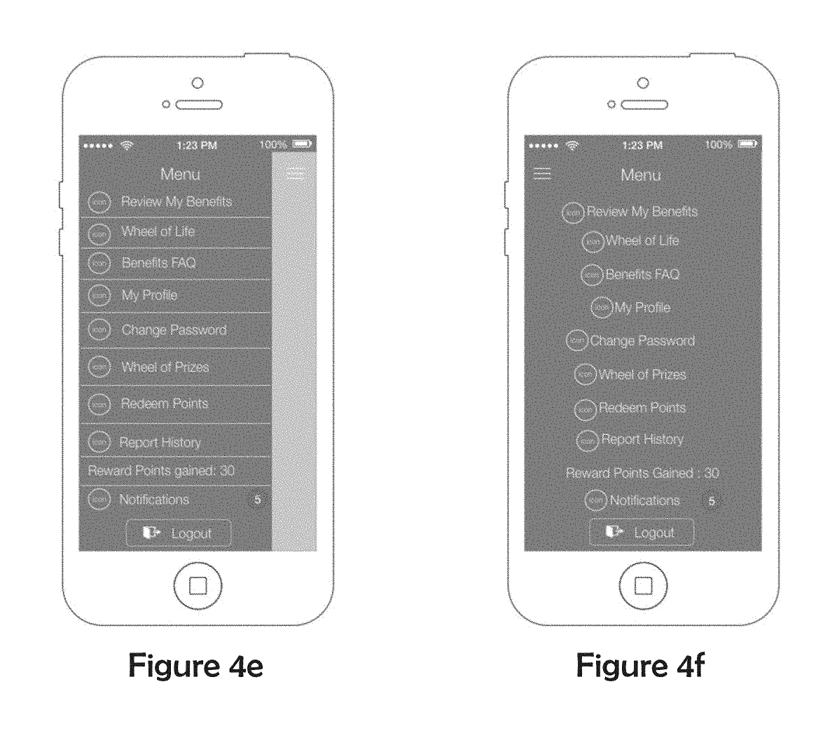

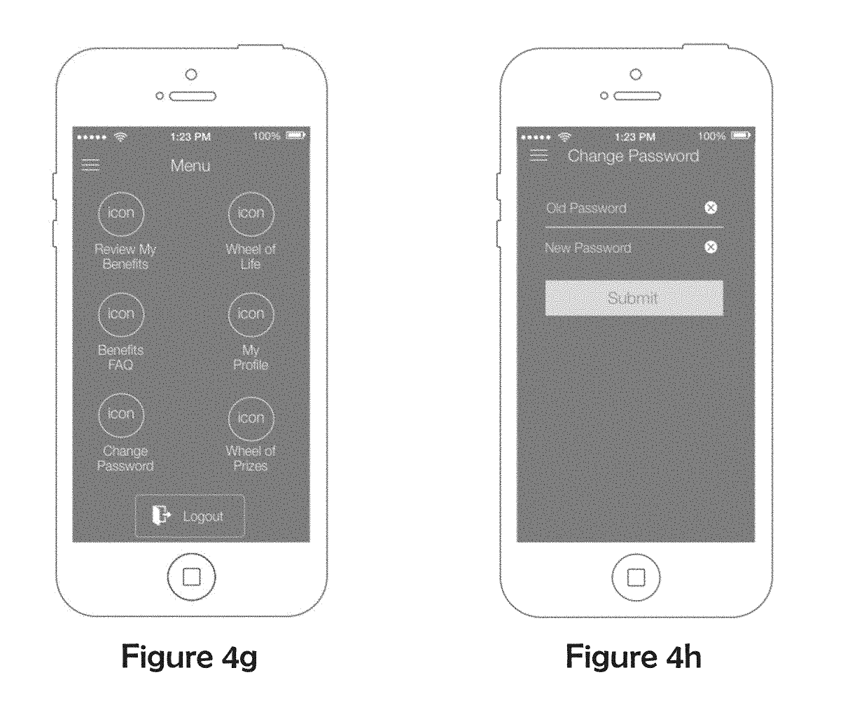

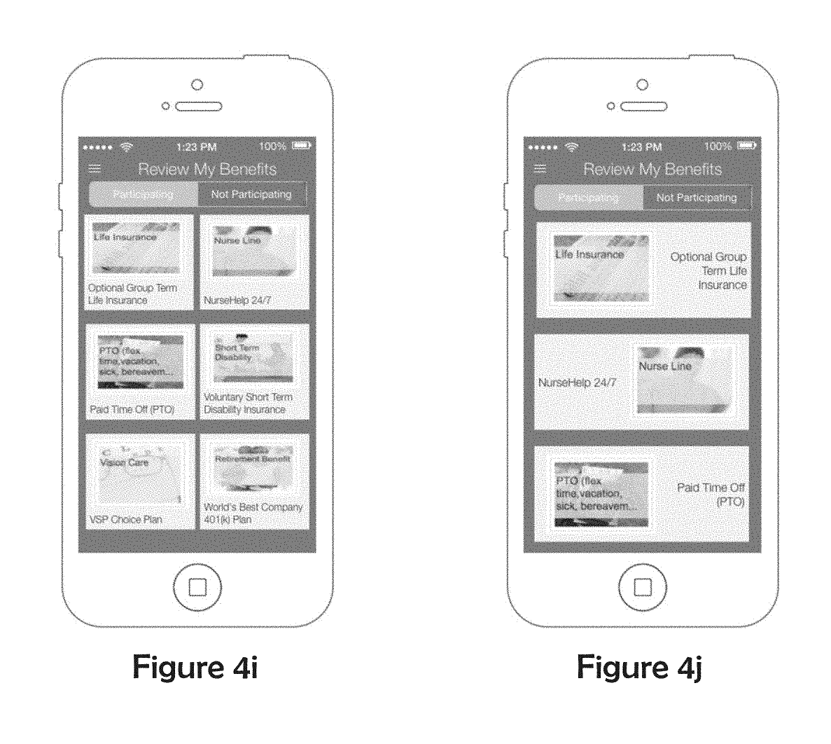

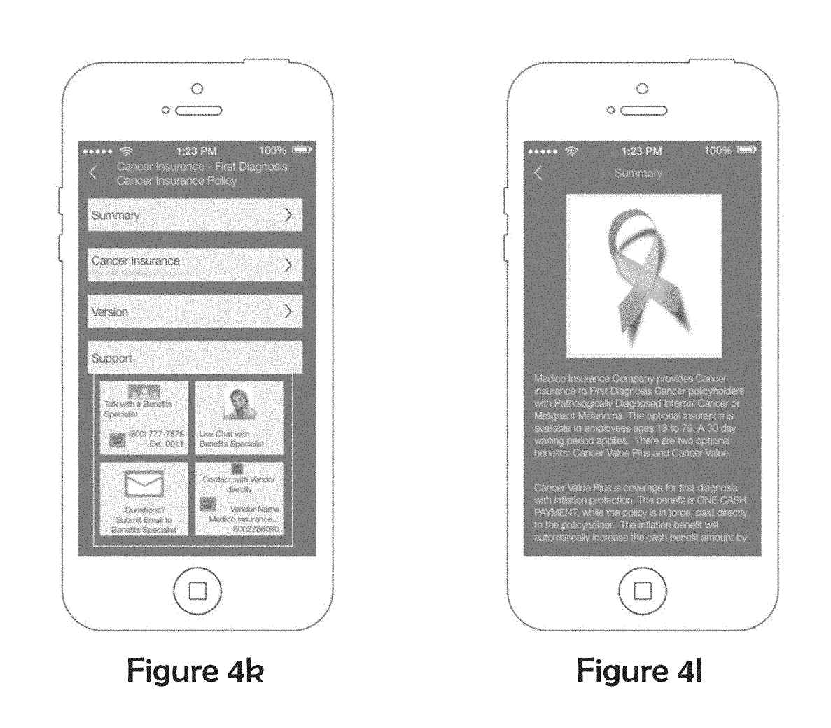

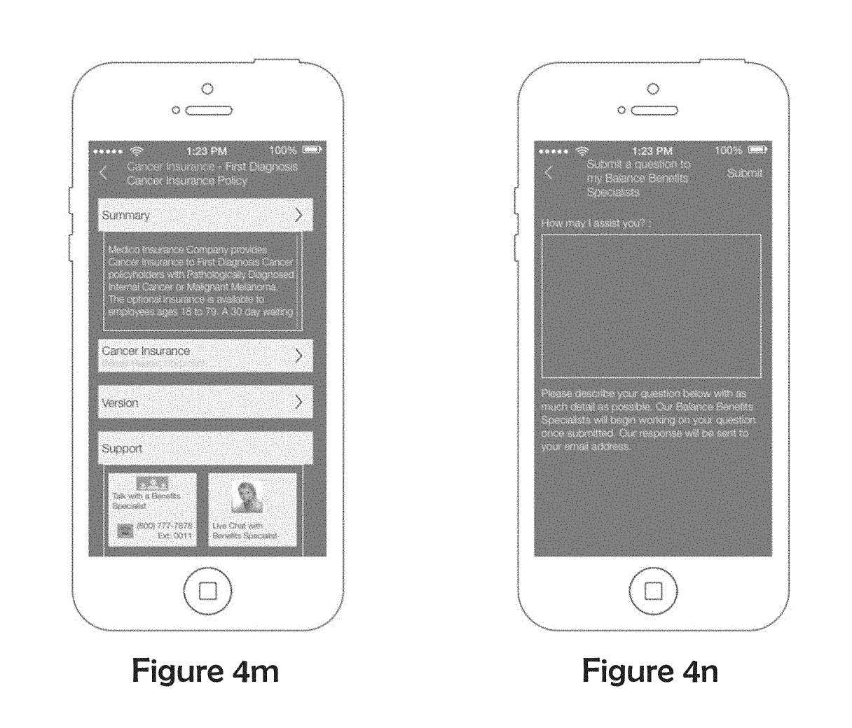

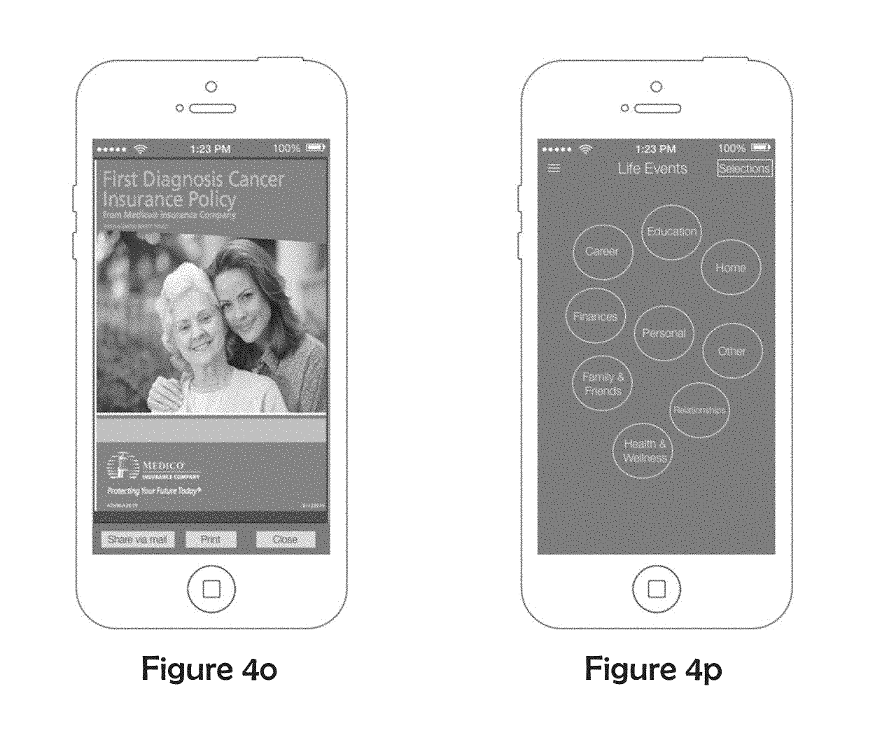

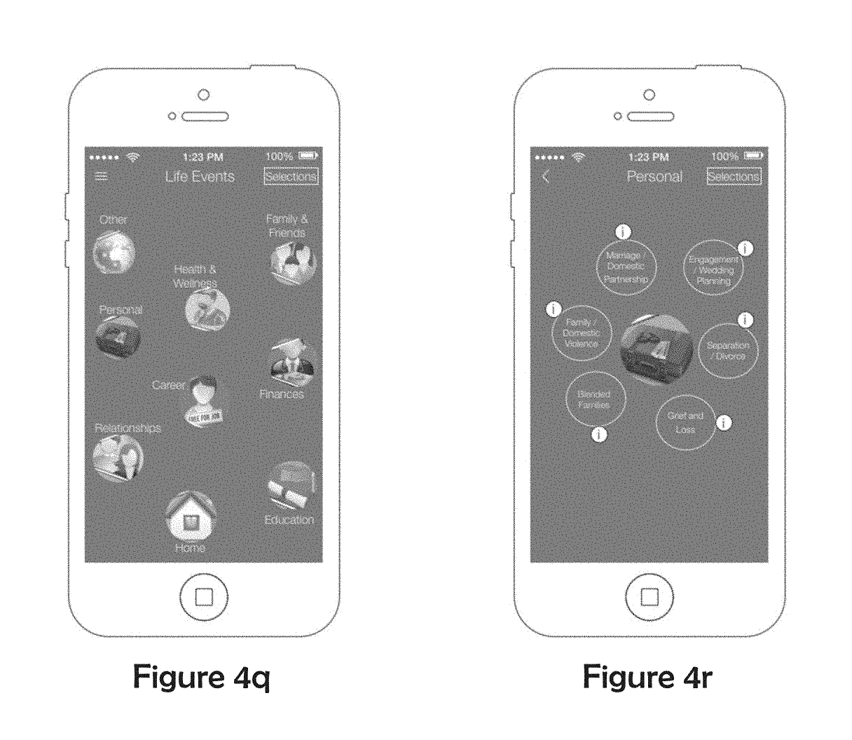

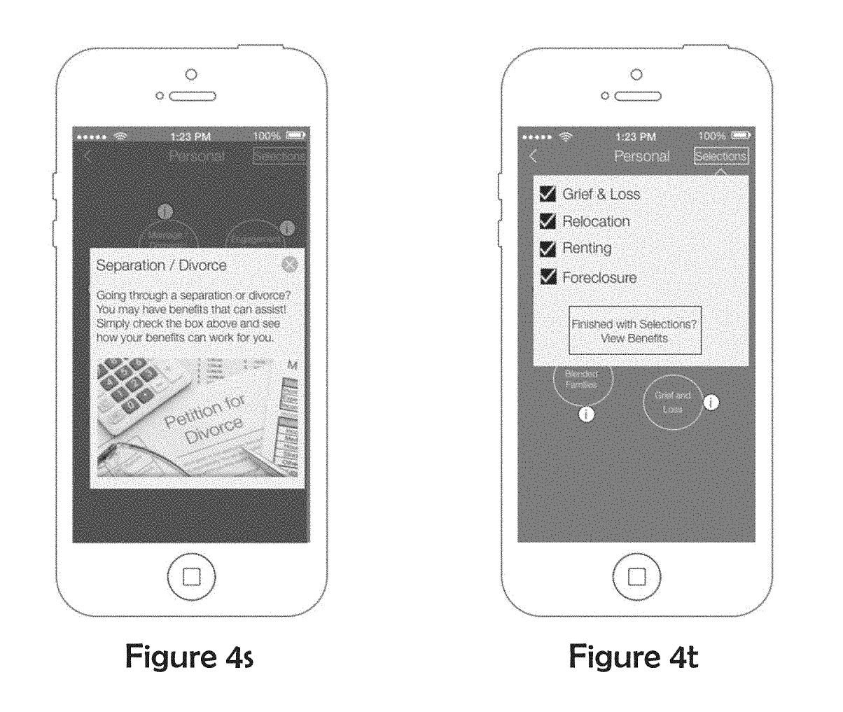

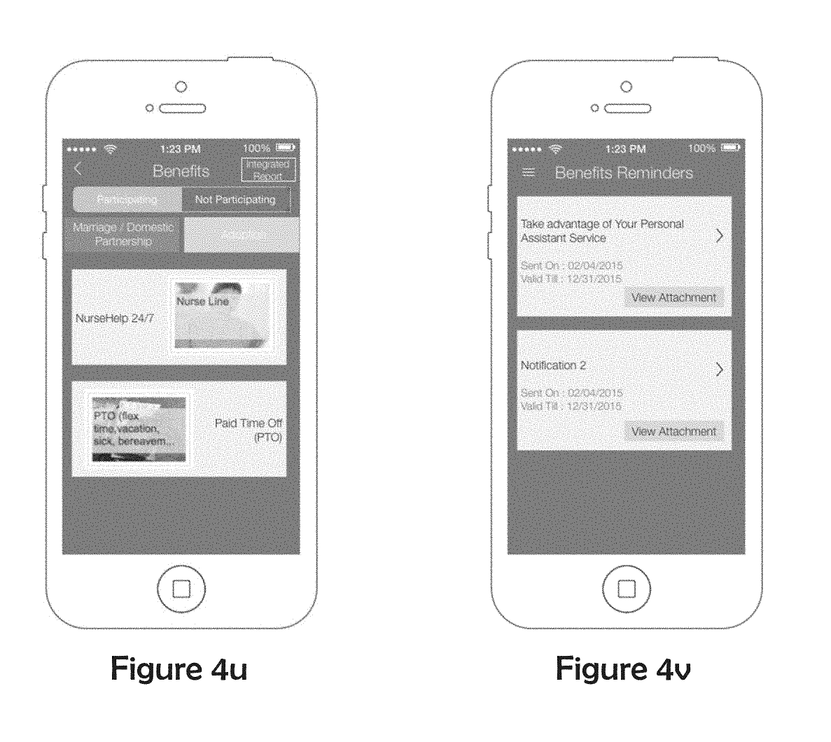

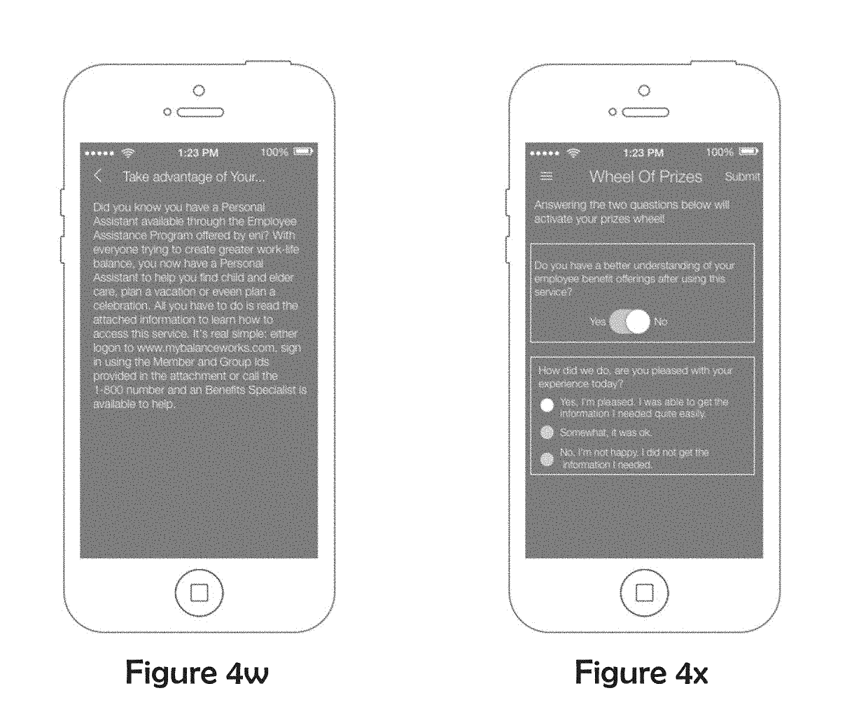

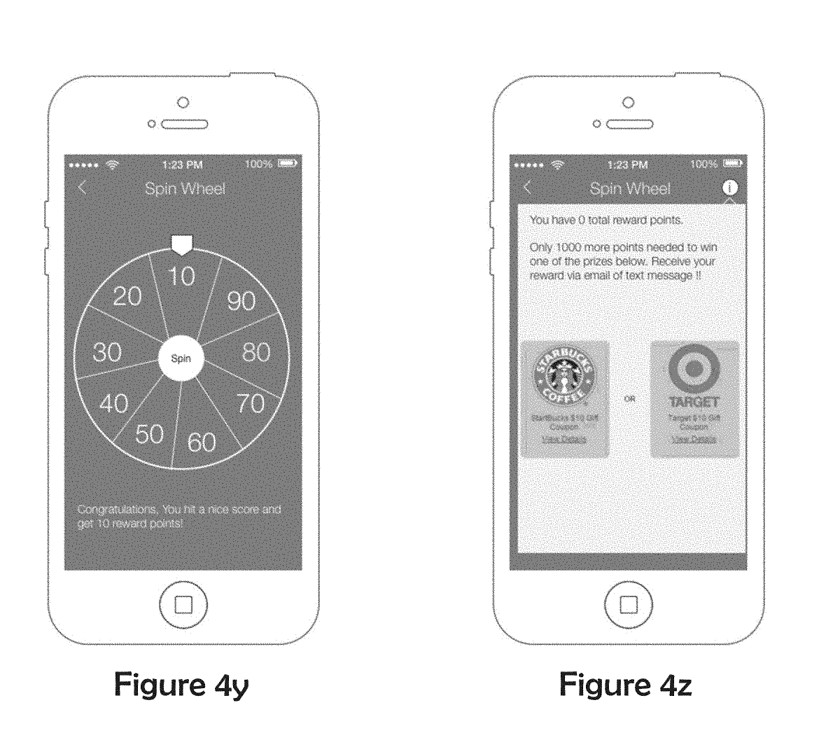

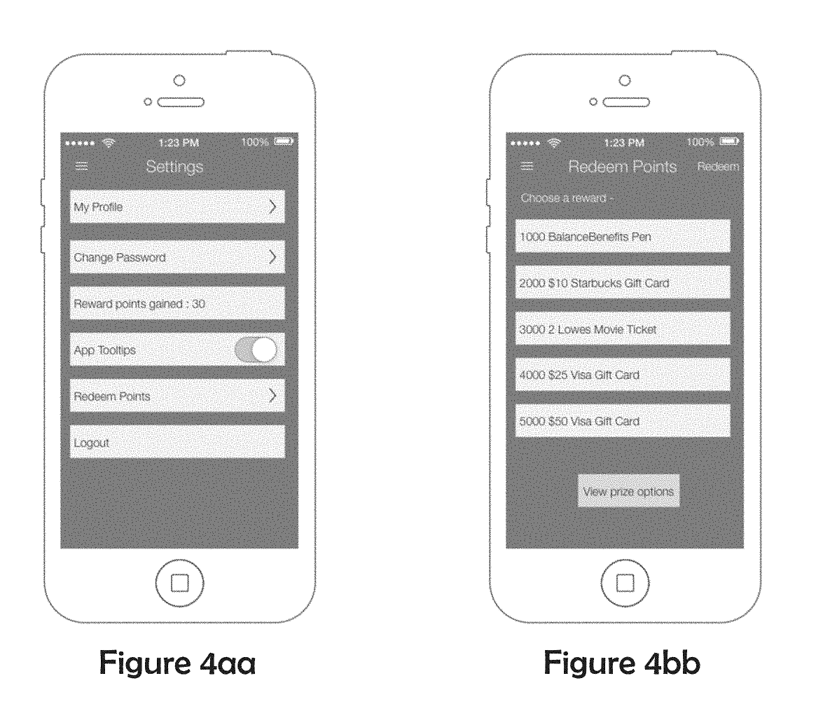

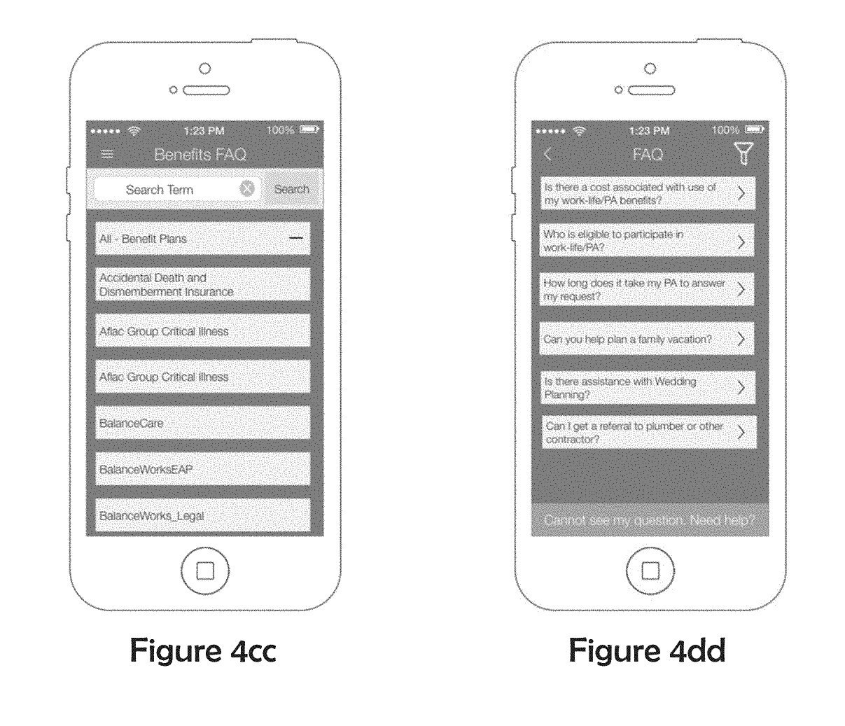

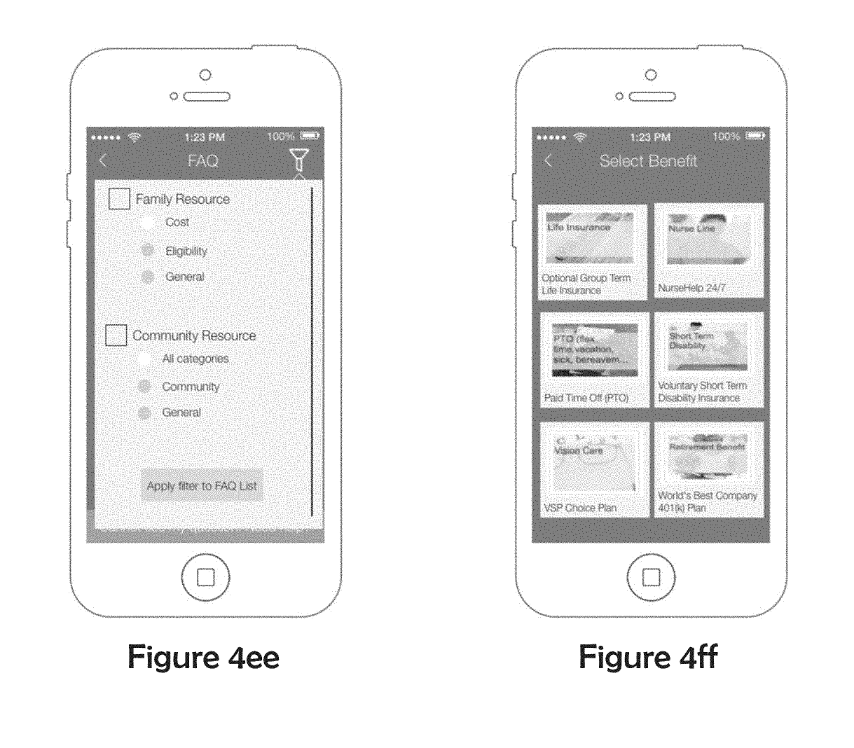

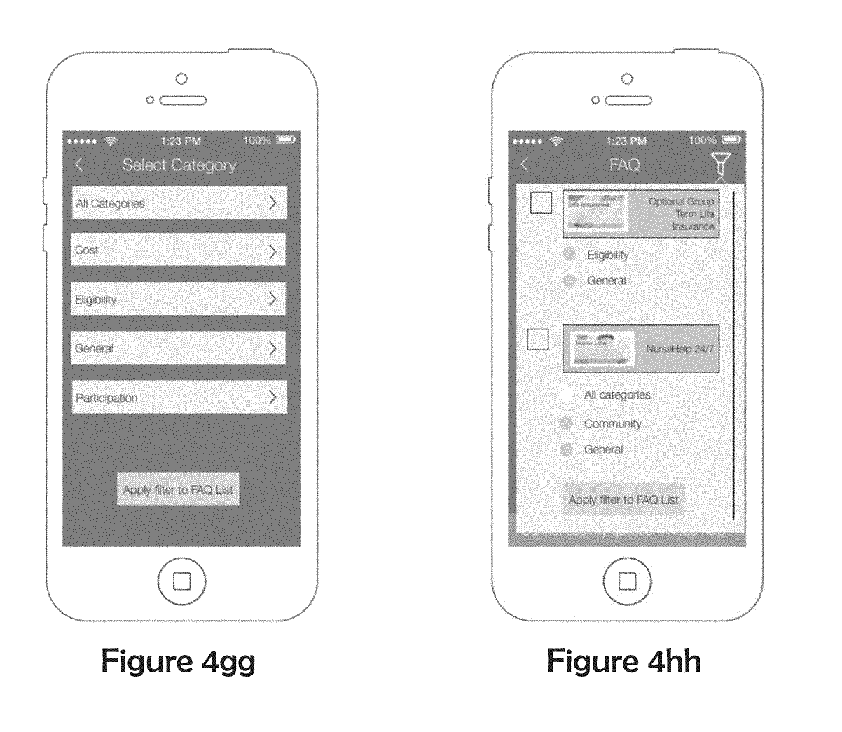

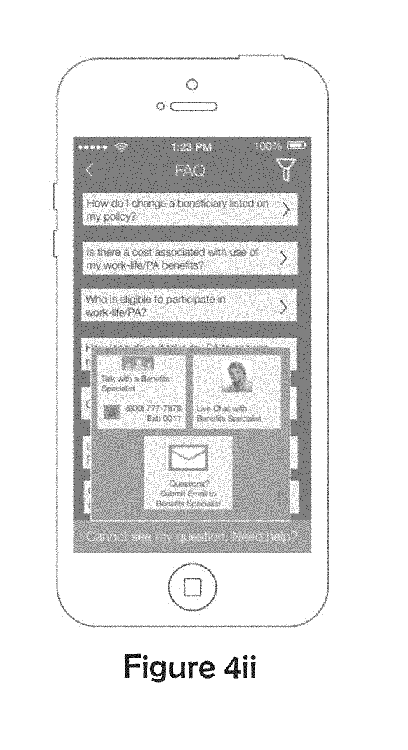

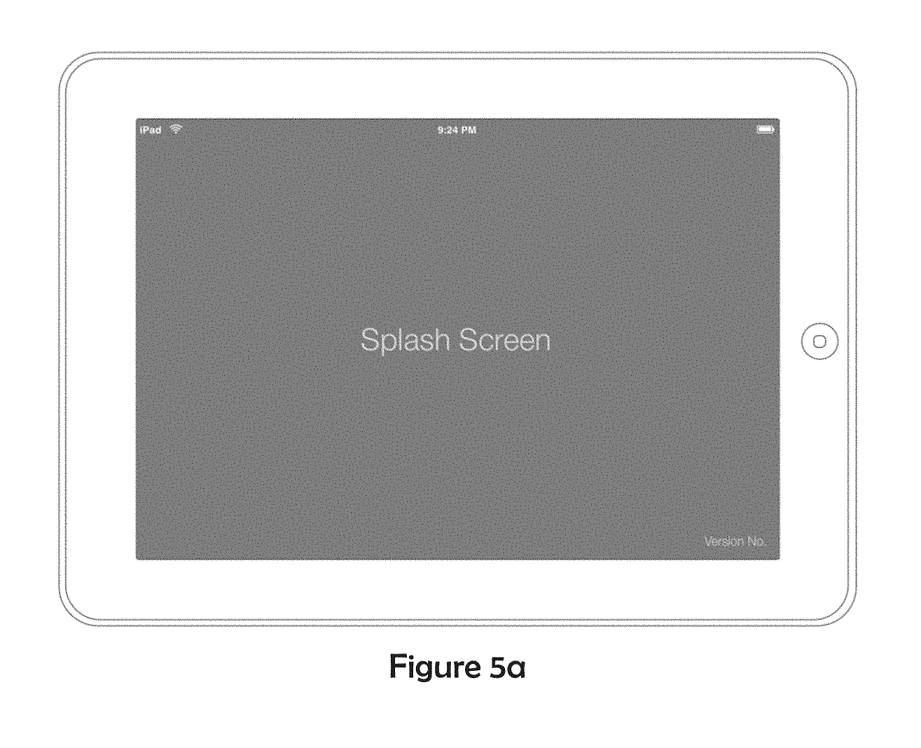

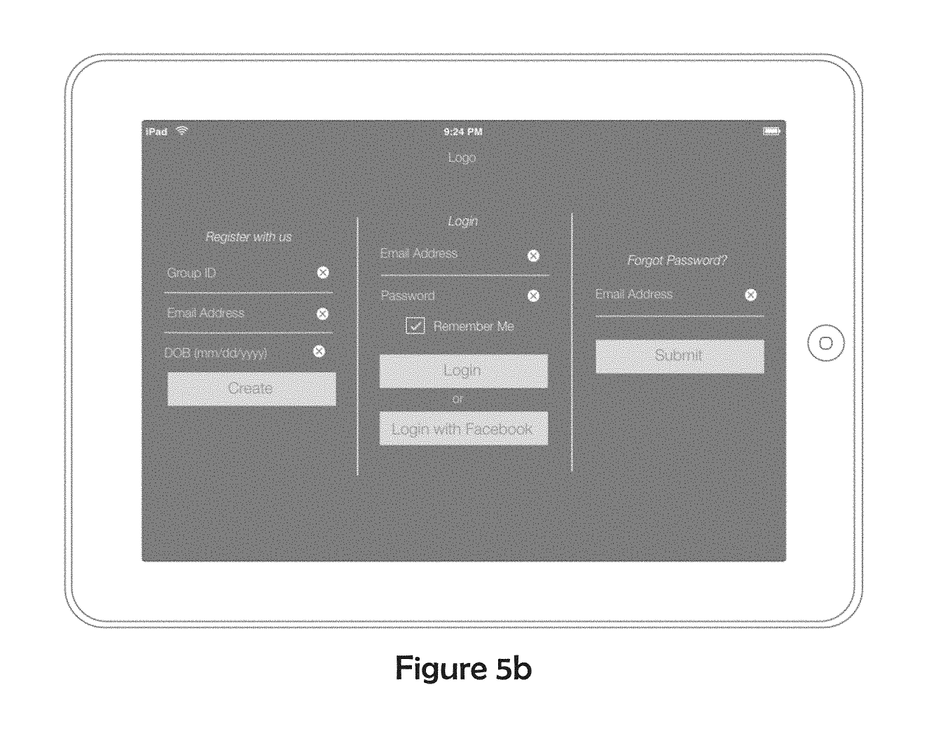

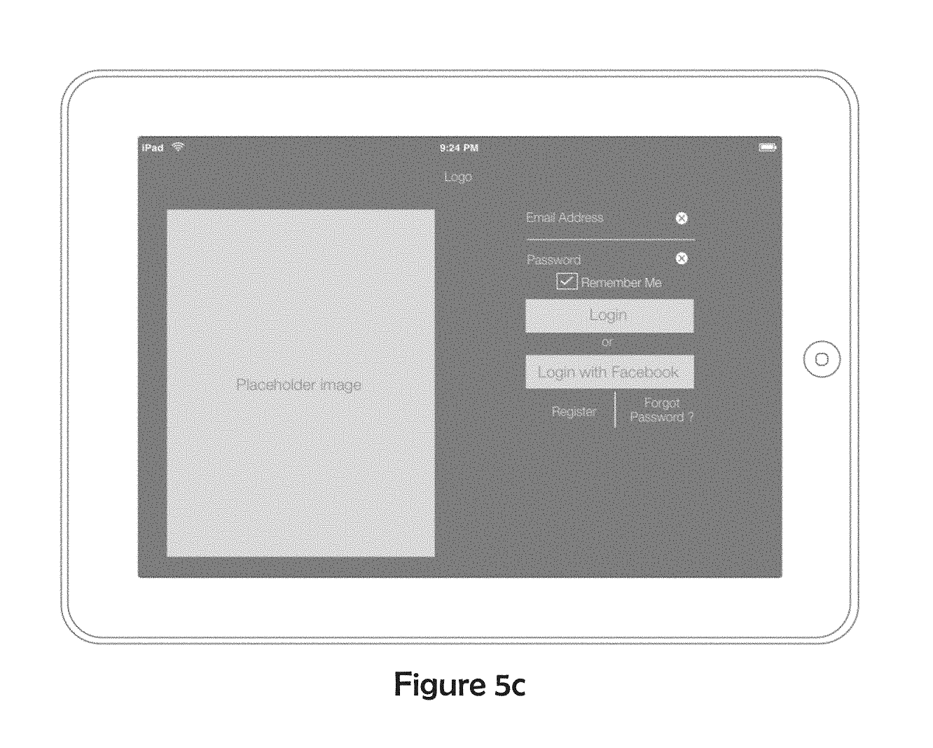

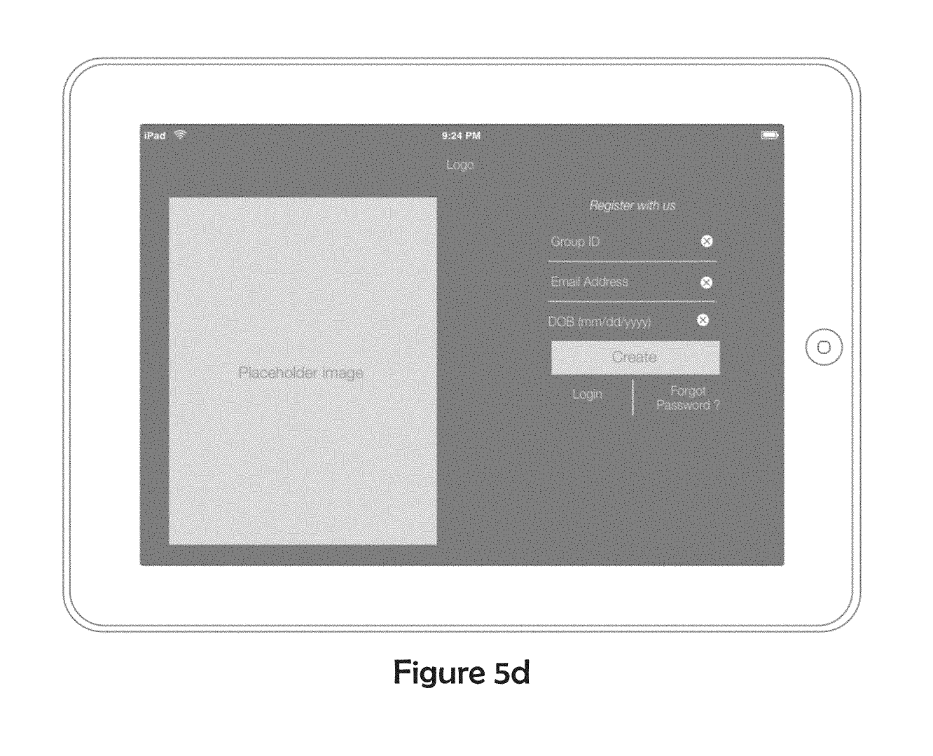

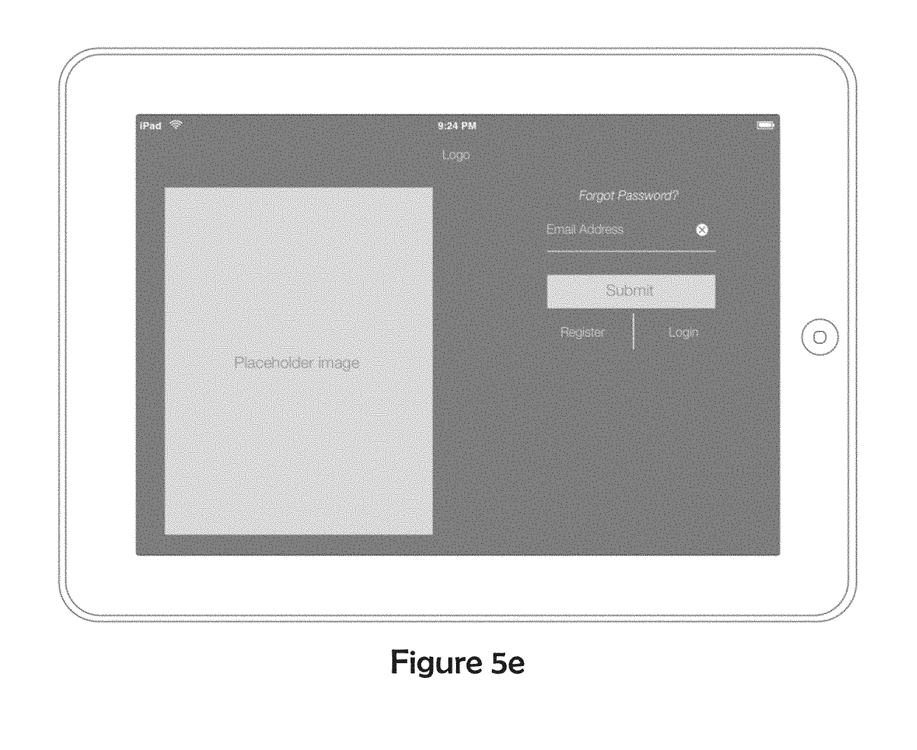

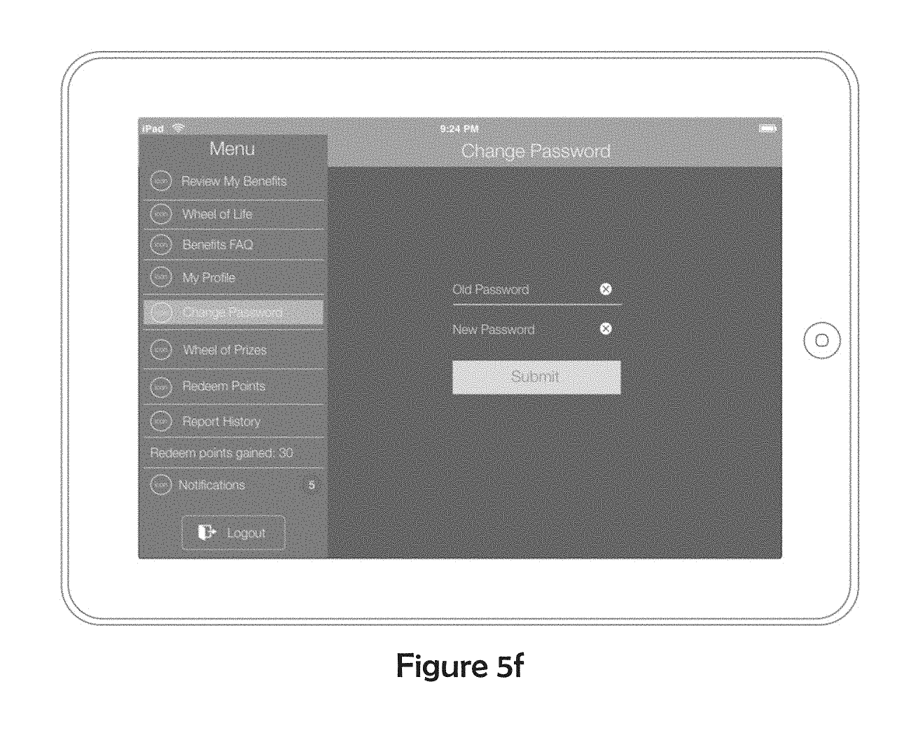

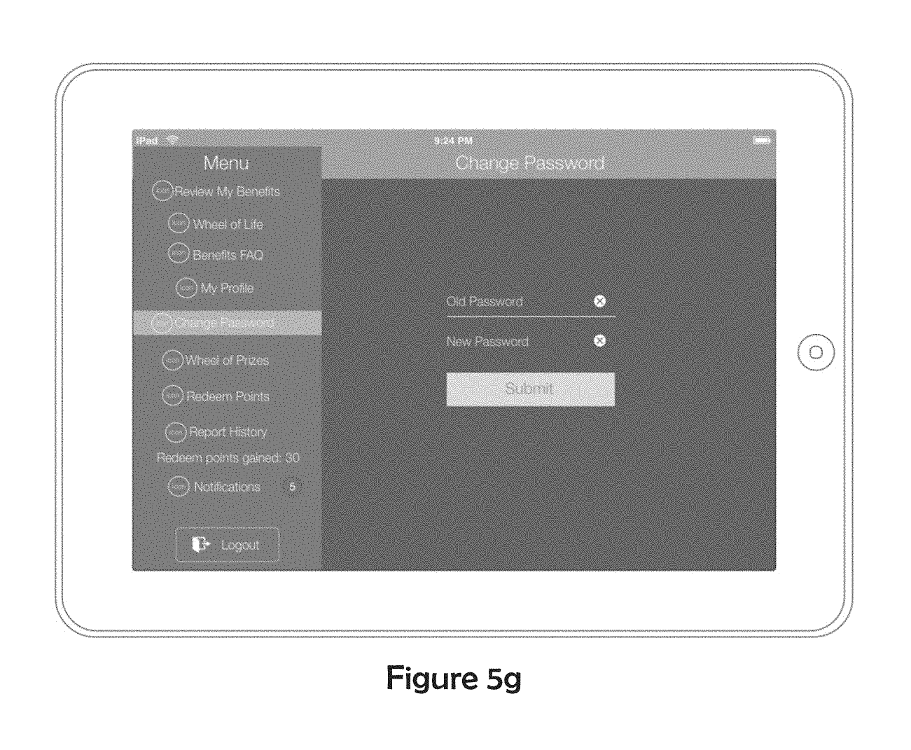

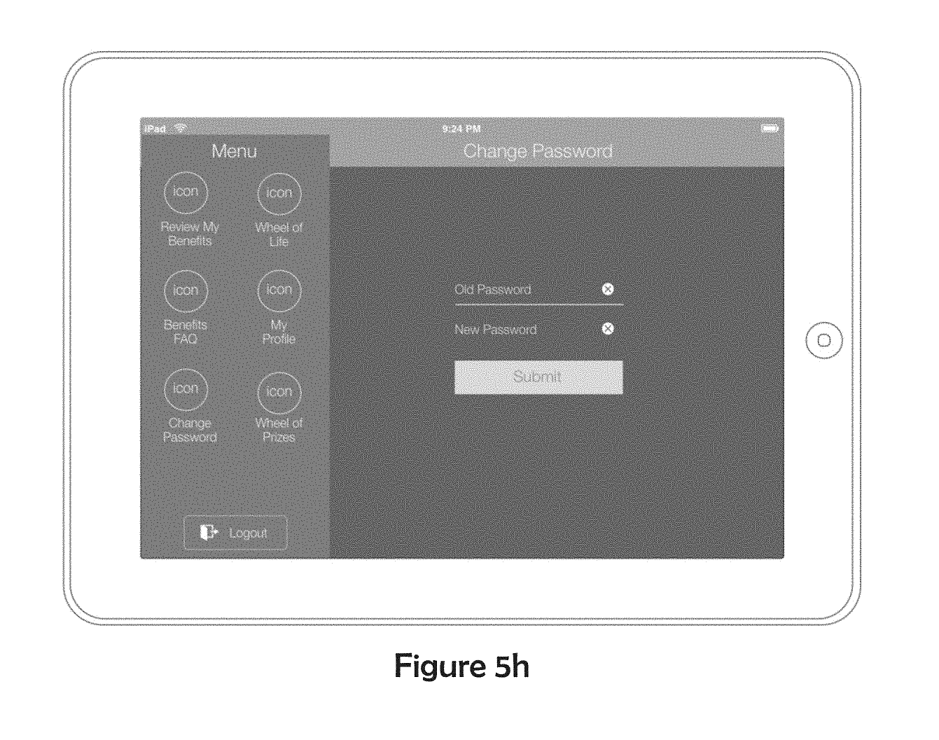

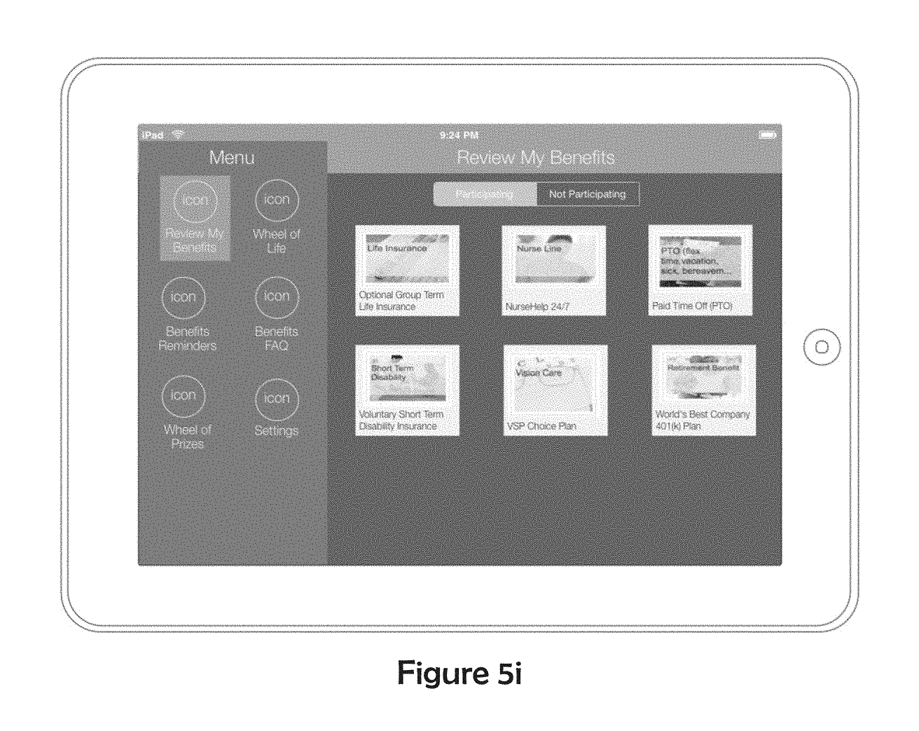

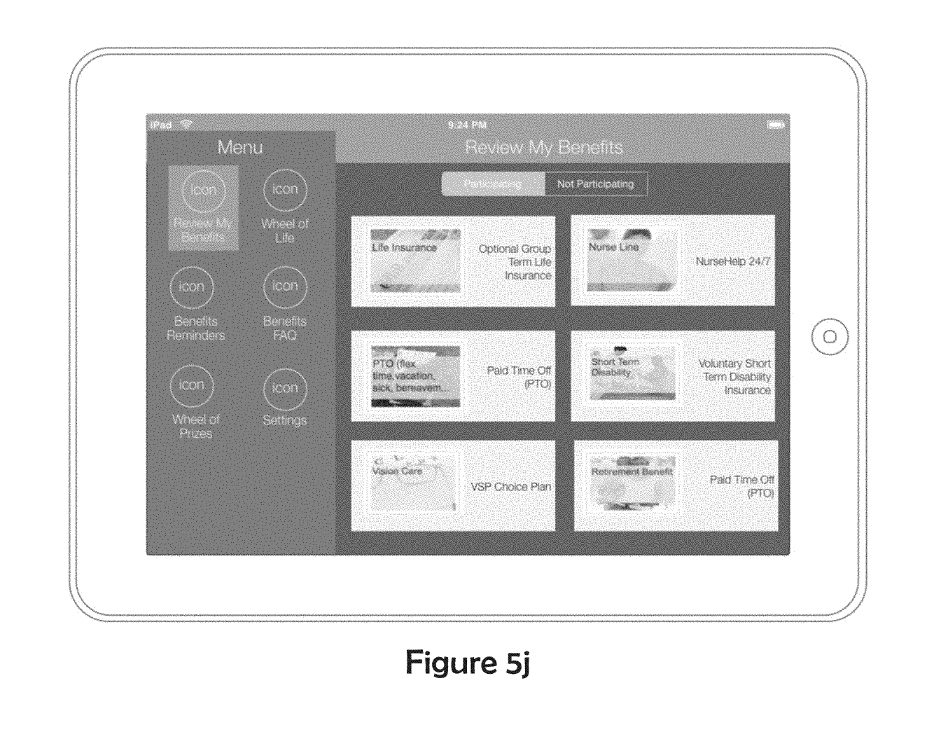

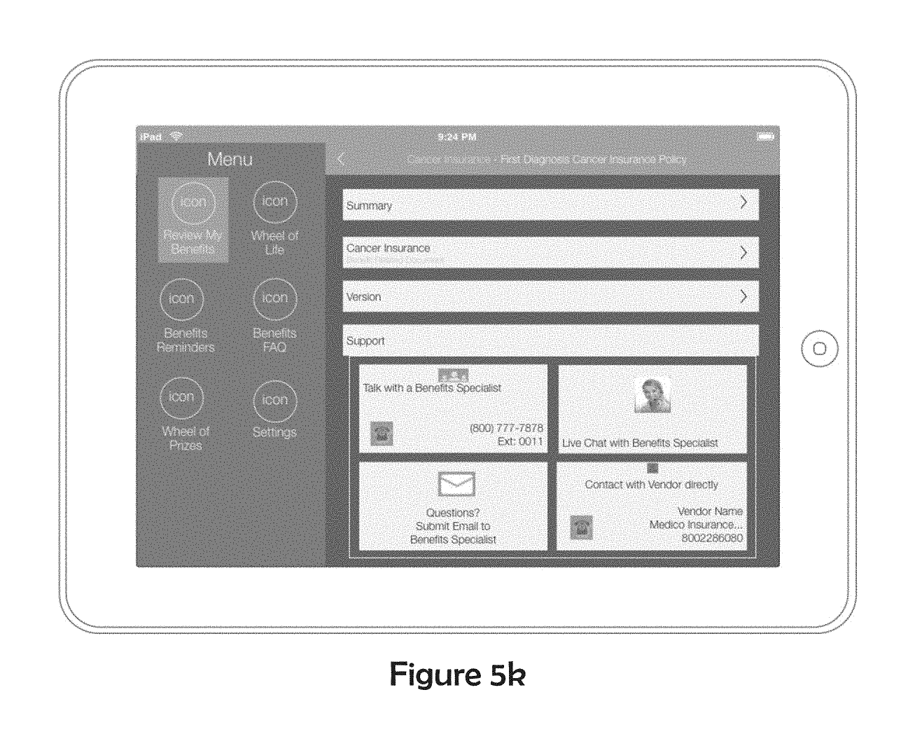

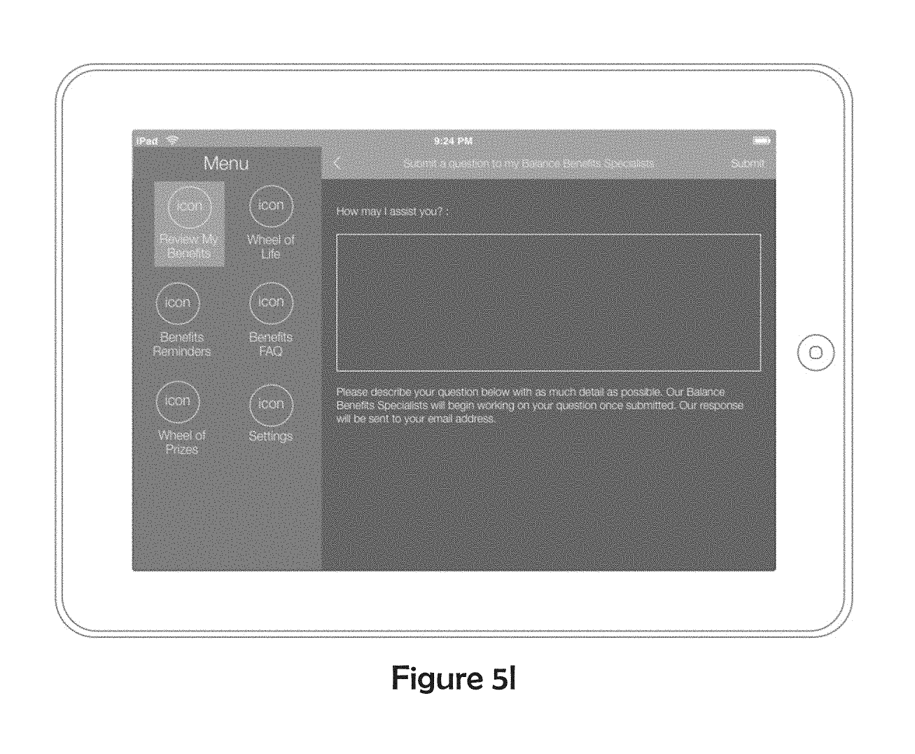

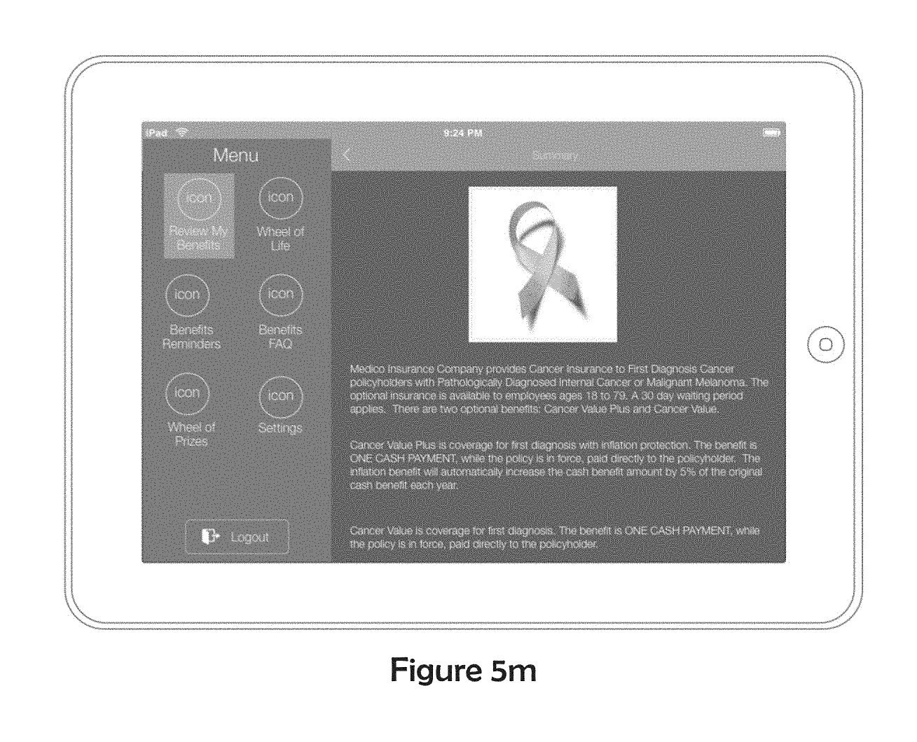

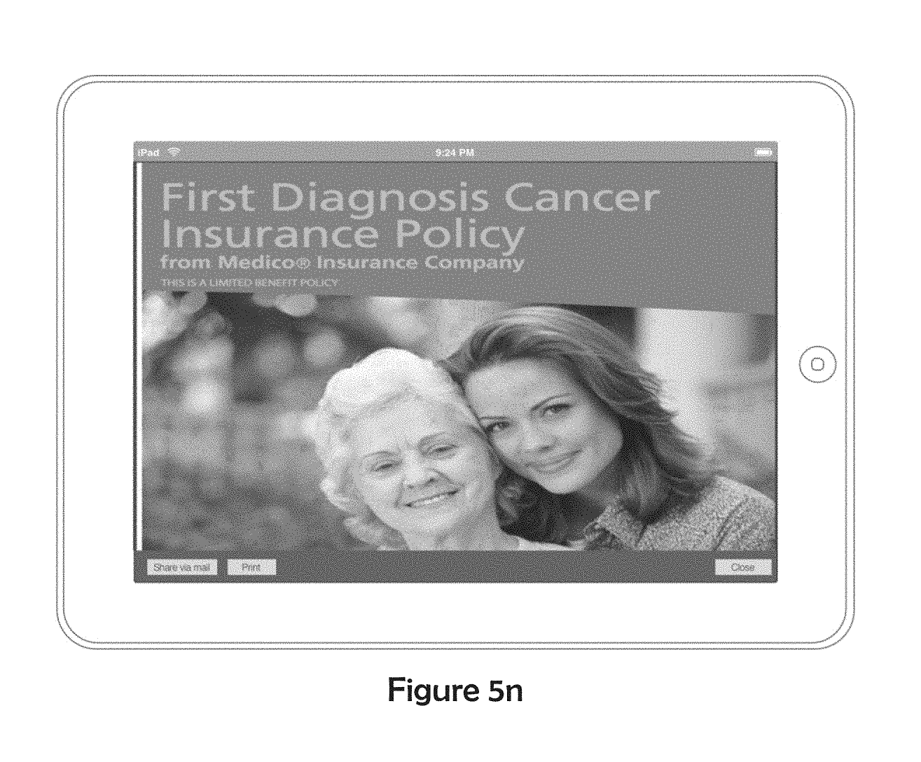

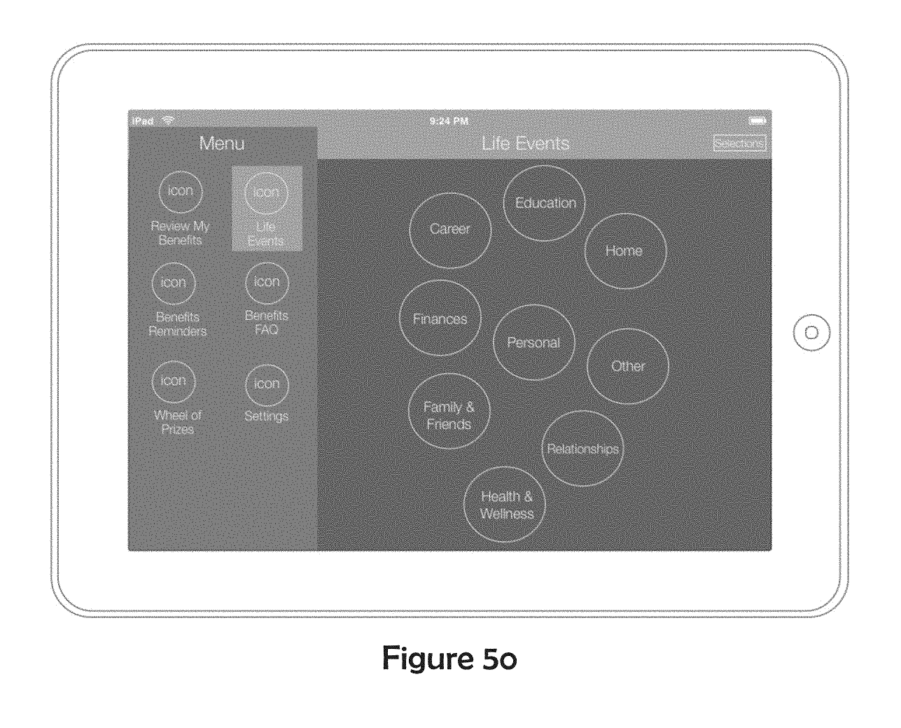

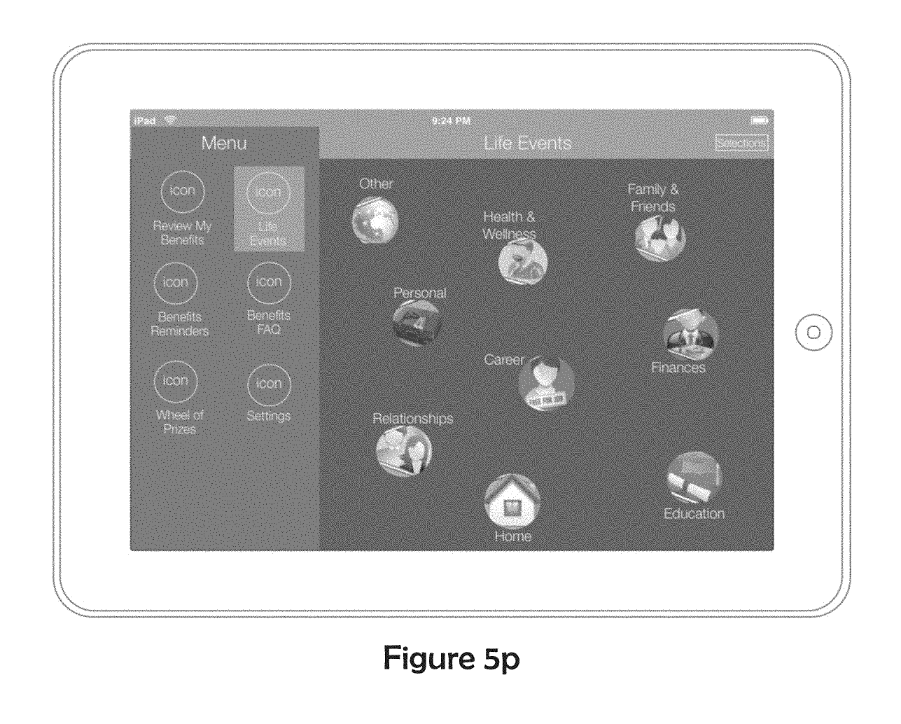

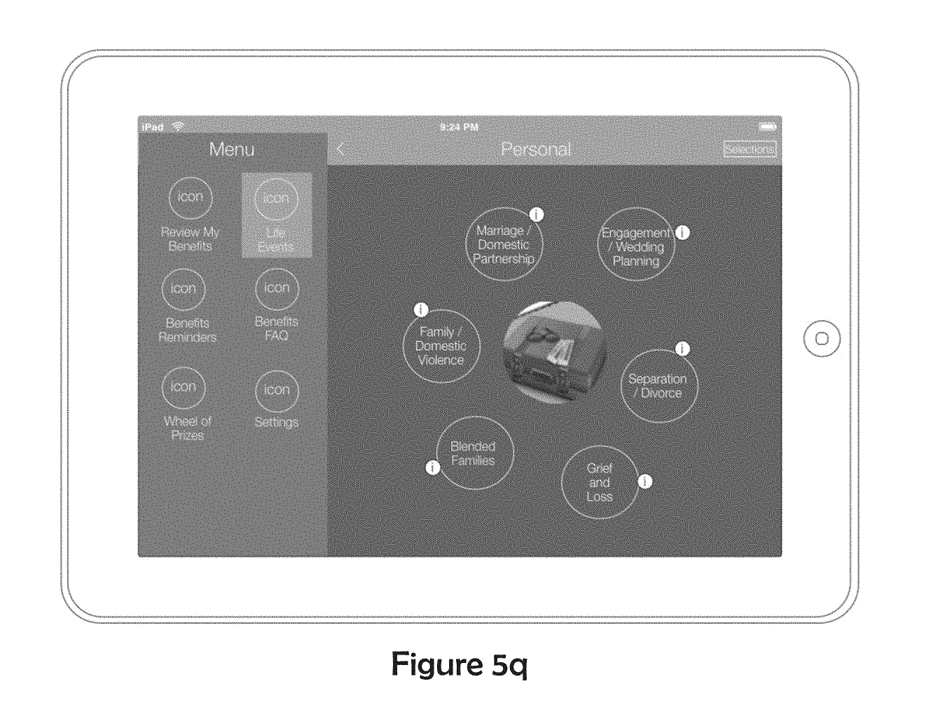

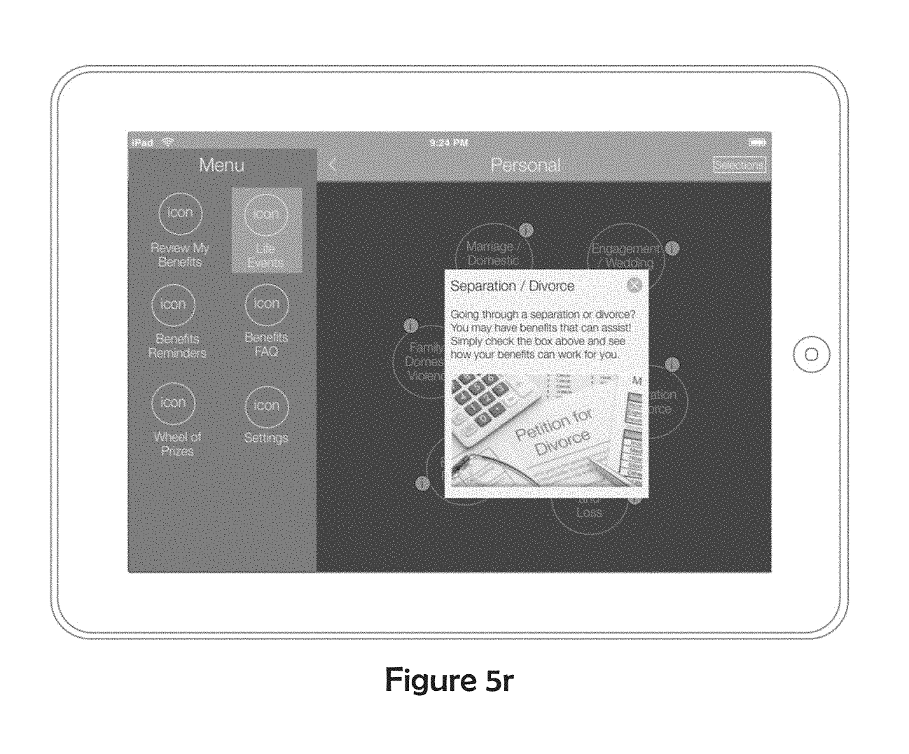

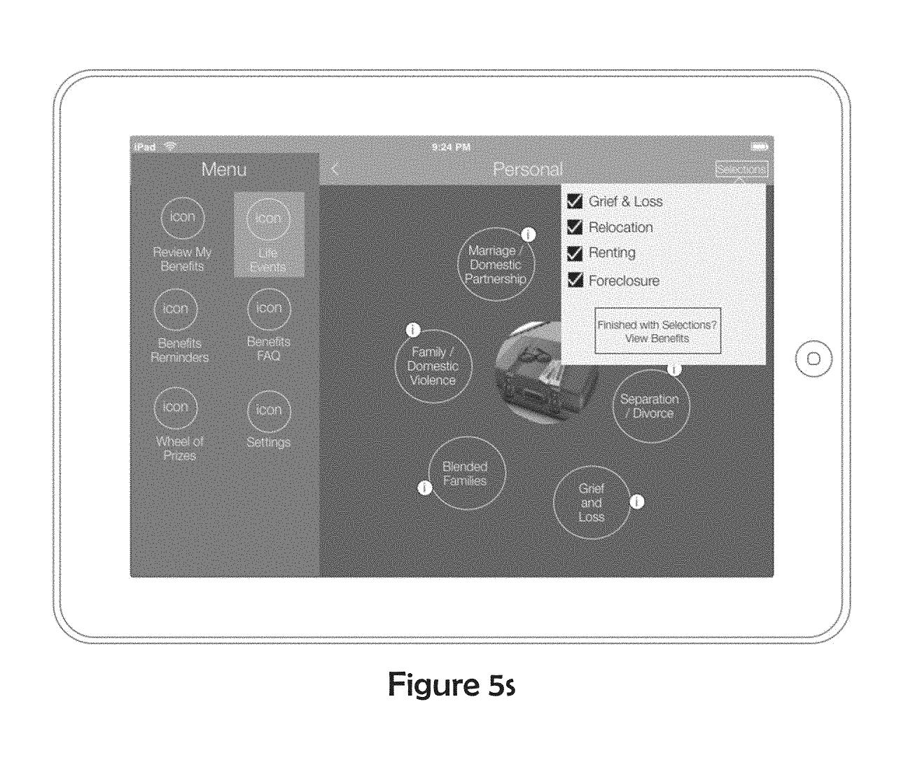

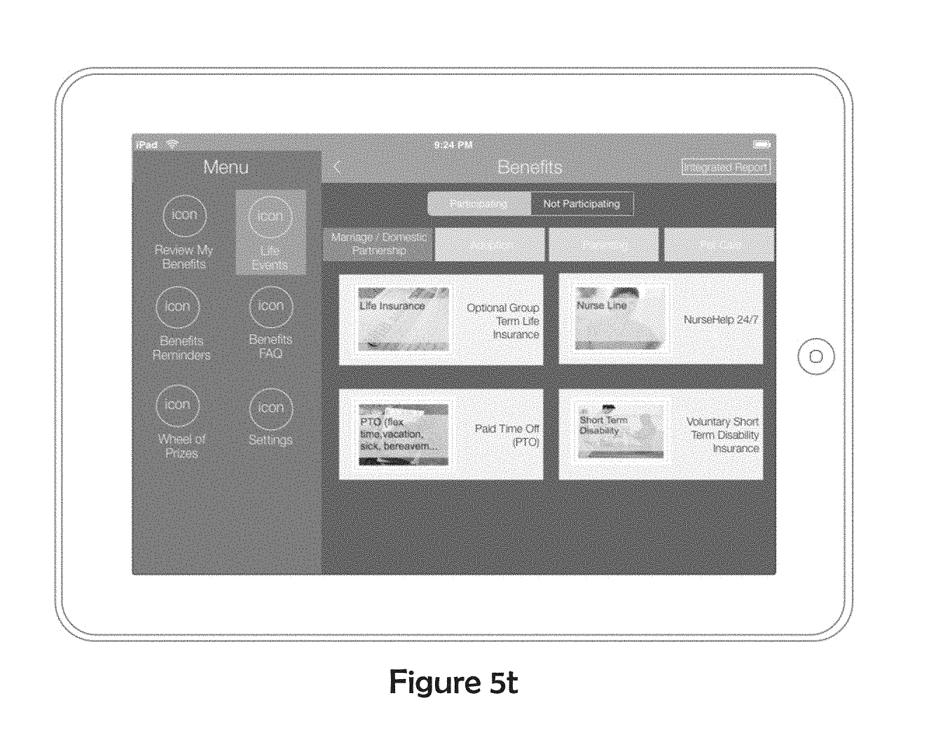

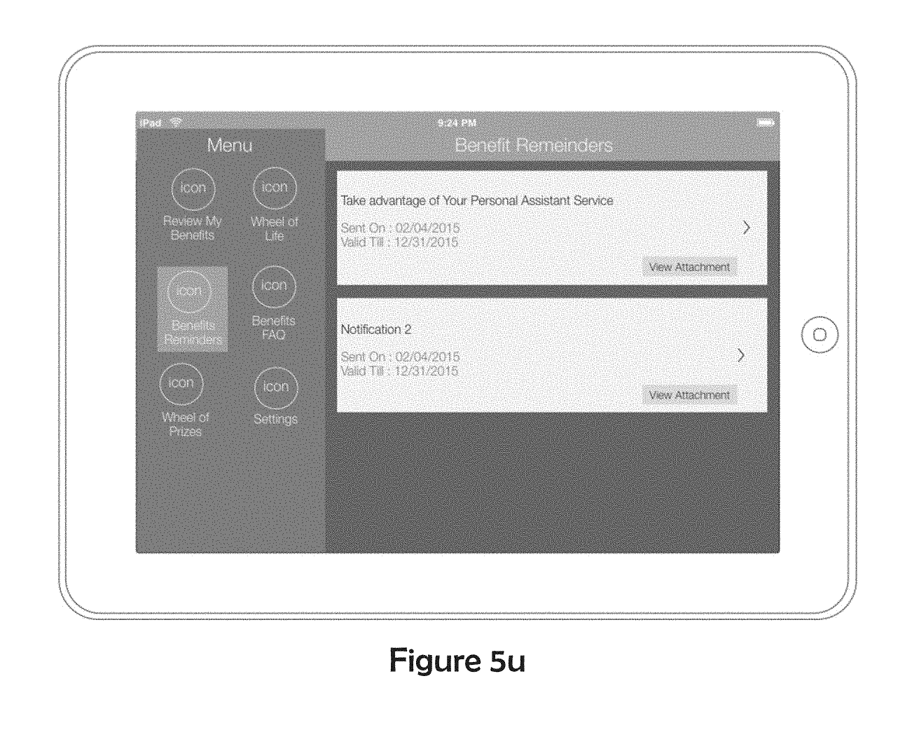

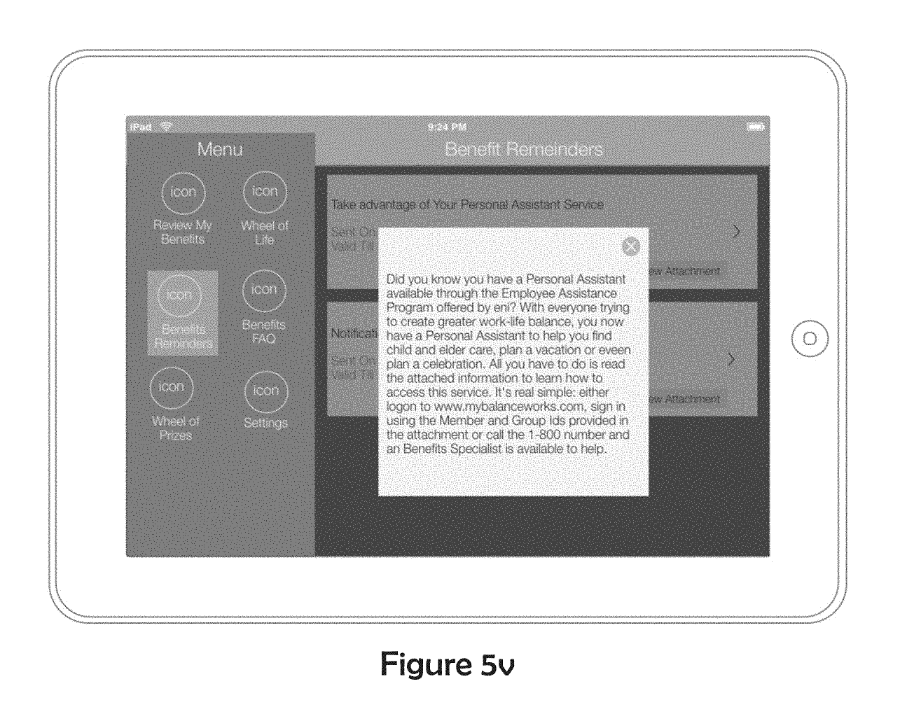

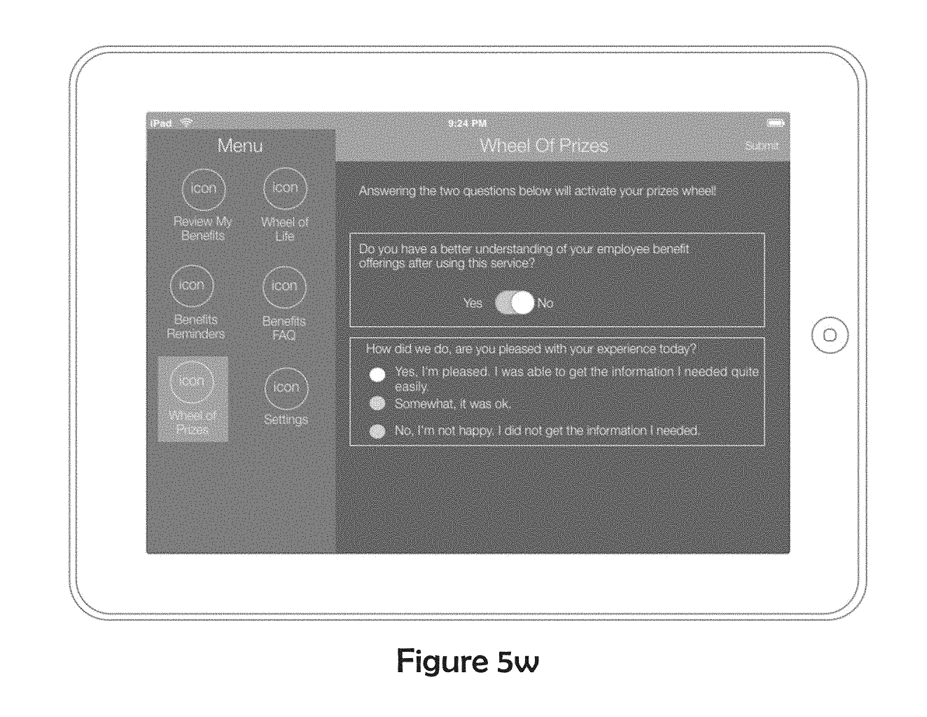

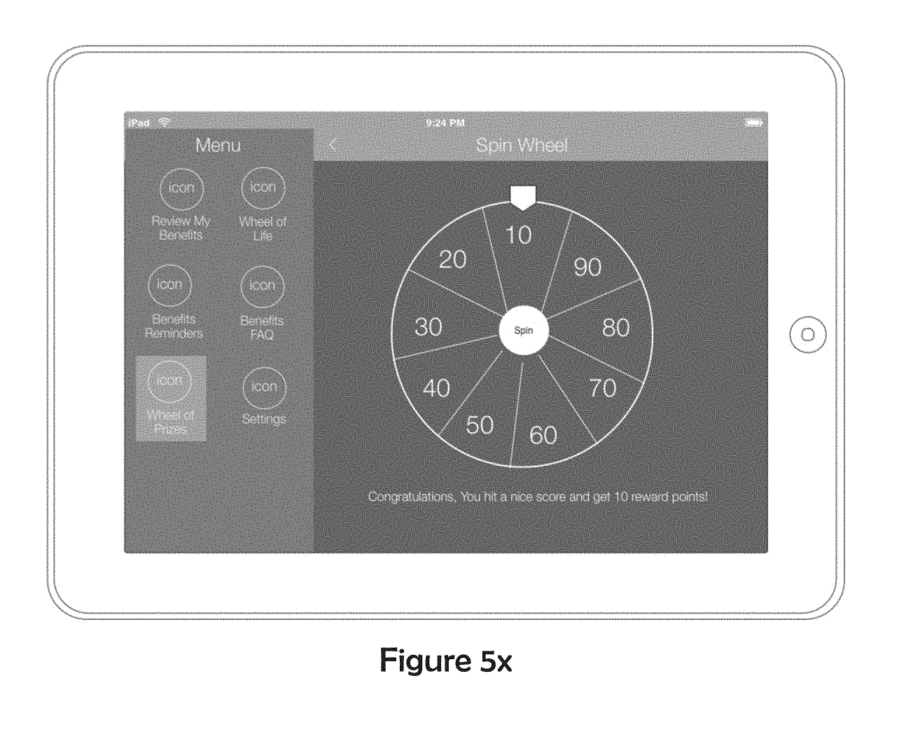

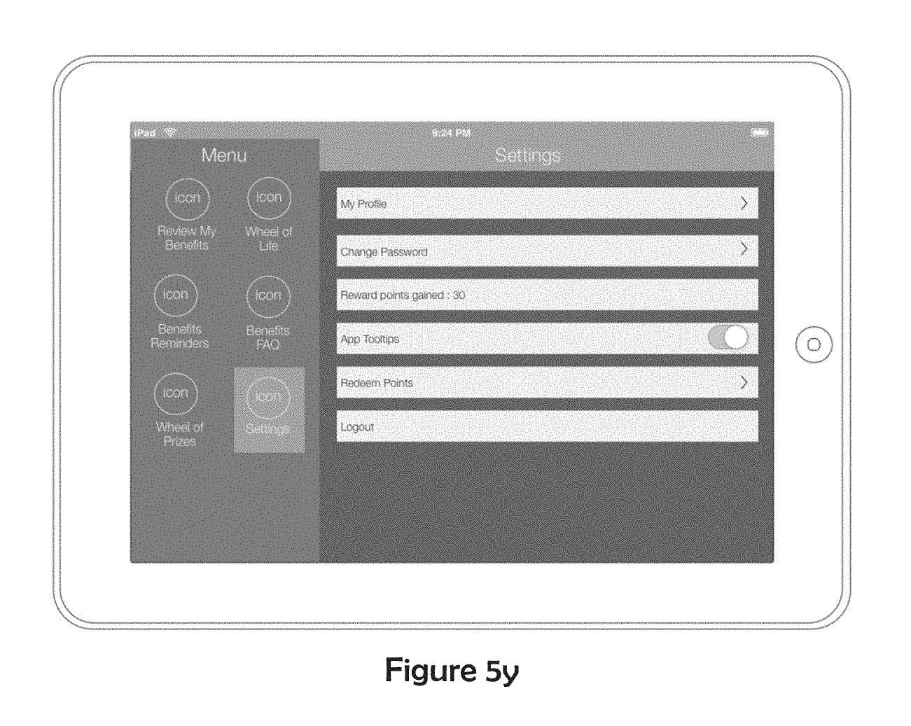

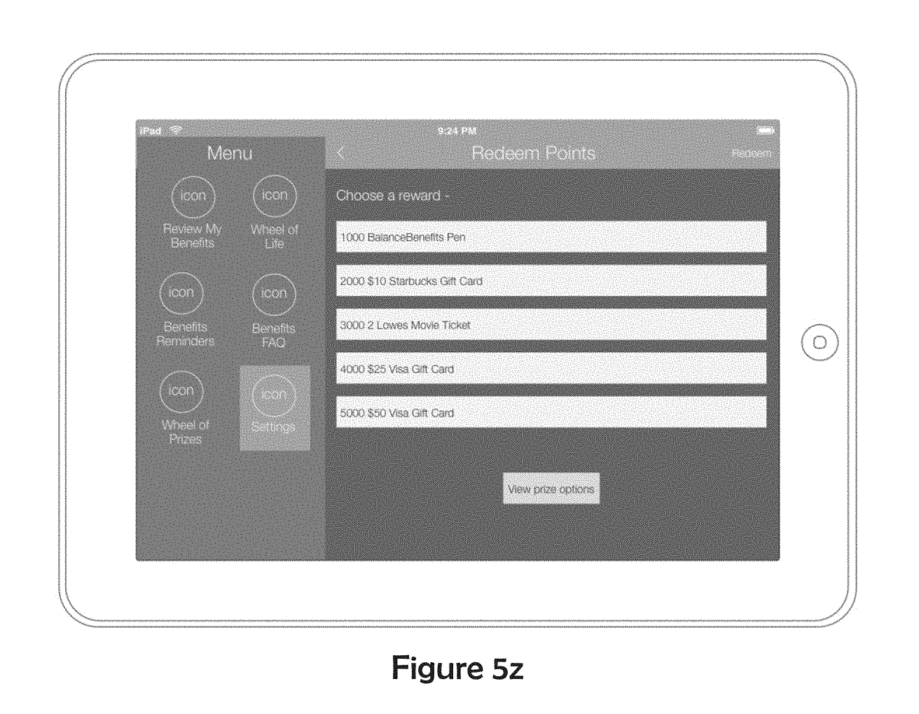

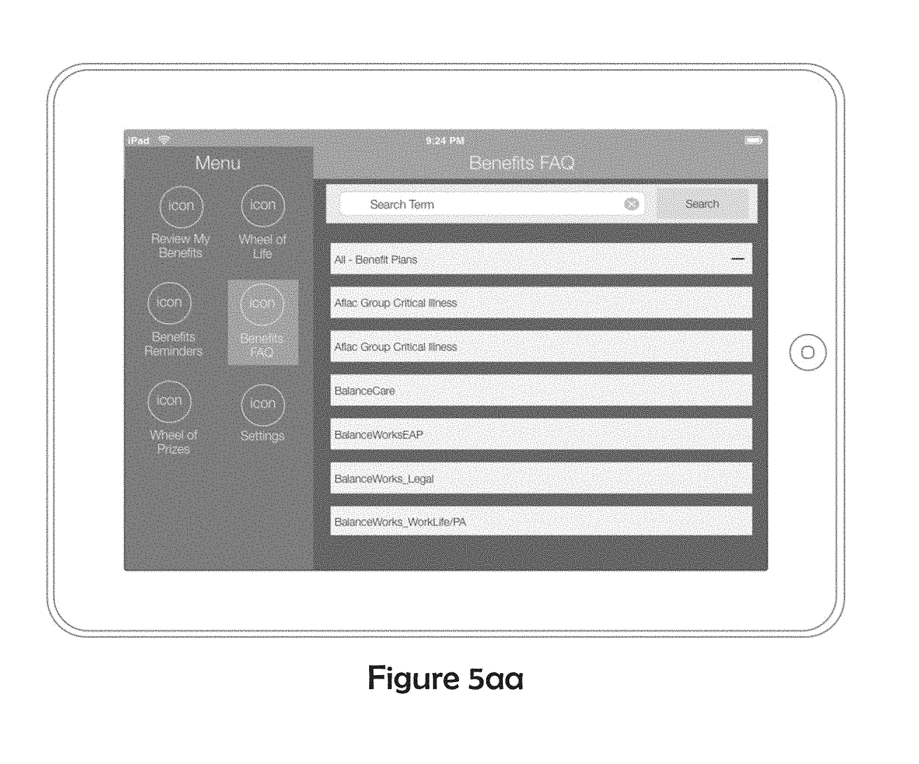

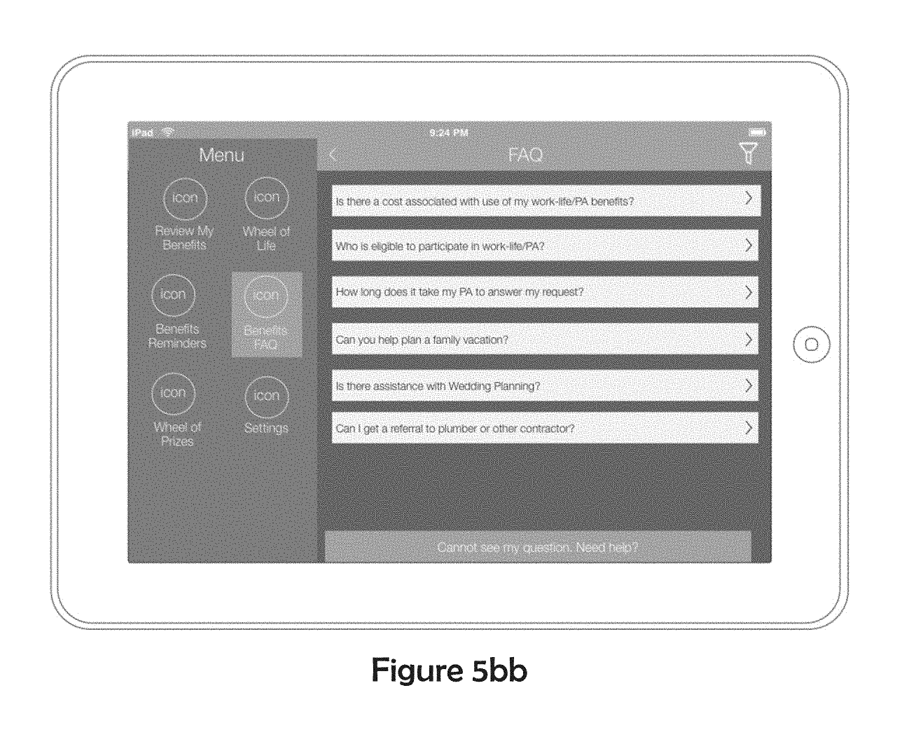

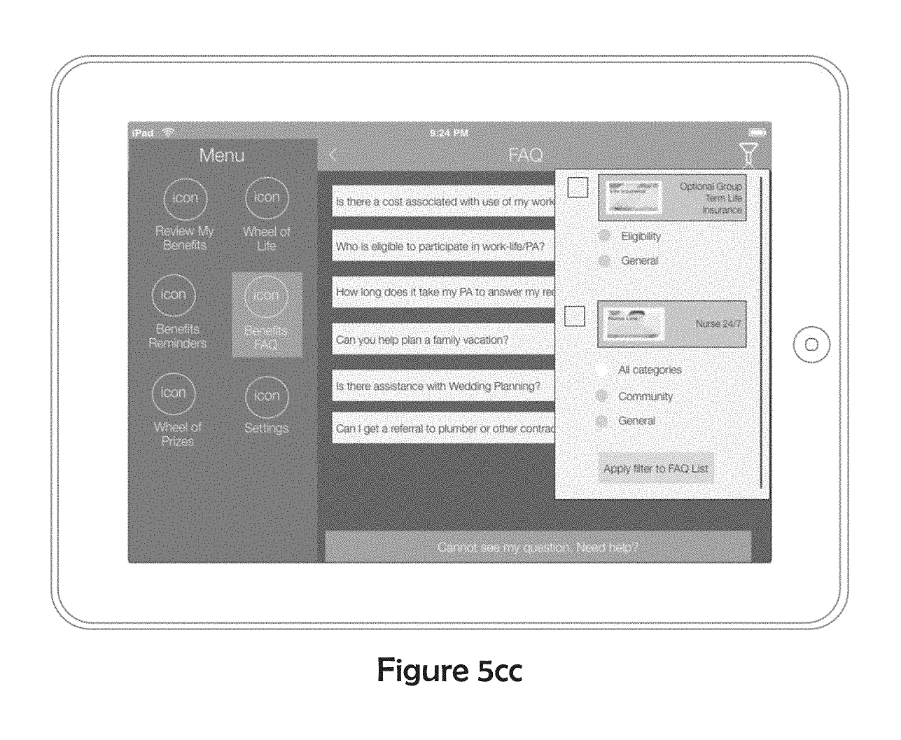

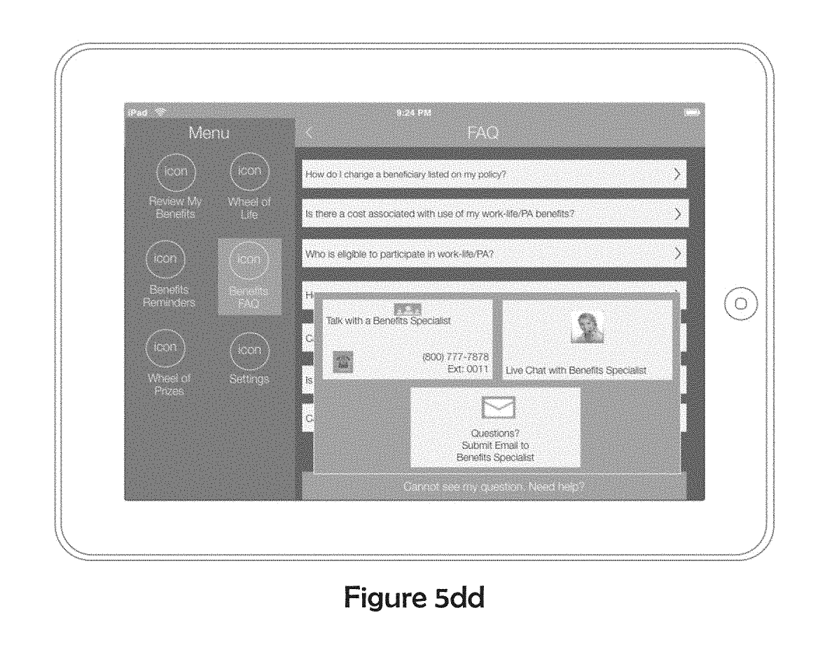

As explained further, infra, the diagram of FIG. 1 is but one example of how life experiences may be categorized according to the present invention. In other examples, life experiences may be delineated much specifically. In one preferred embodiment of the present invention, shown in FIGS. 4p through 4t, it can be seen how a user of the present invention may navigate benefits from a high level (similar to FIG. 1) to much more specific needs.

Logging into Benefit Information Specialist (BIS) Administrative Control Portal

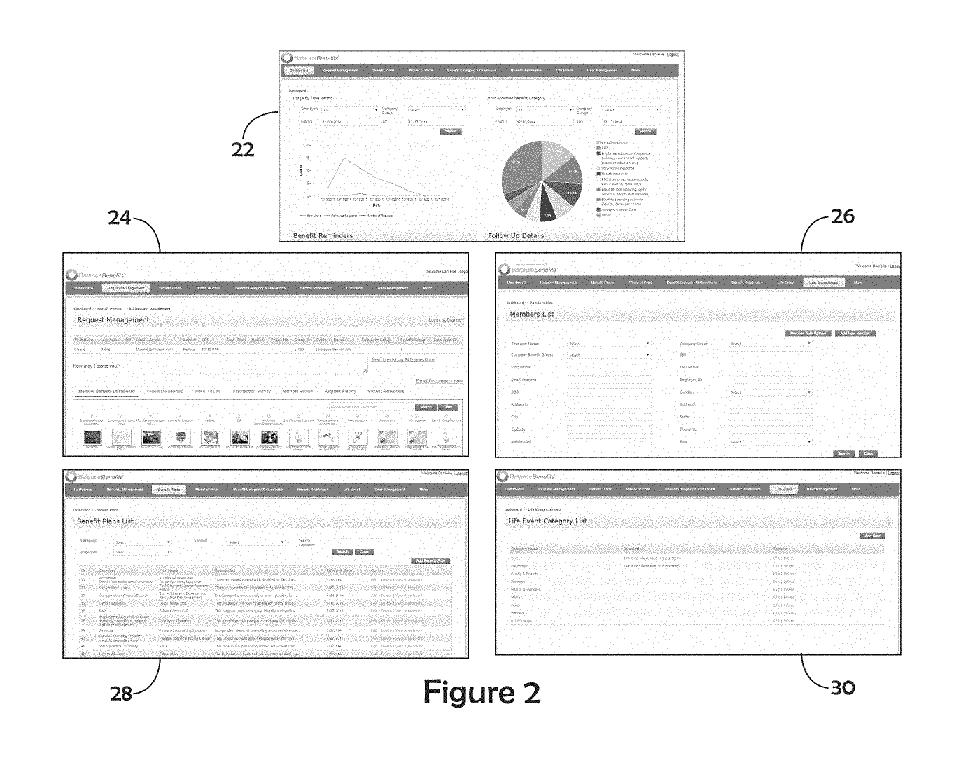

With reference to FIG. 2, there is shown a series of computer displays according to which the present invention may appear when a user utilizes the present invention on a standard, desktop computer or laptop computer. Reference numbers 24, 28, and 30 show how a computer display may, according to the present invention, enable users to navigate information about their available employment benefits by categorizing the benefits according to life events.

User profiles for any specific user of the system claimed herein may be created by an employer, an EAP provider, or any other person or entity. Merely setting up a log in portal so that a user may log in to access the system claimed herein is within the knowledge and skill of a person having ordinary skill in the art.

### Utilizing the Wheel of Life and Generating an Integrated Benefits Report

After an employee has made a benefit information request, the BIS has an opportunity to determine whether the employee has any life event needs, which may or may not be related to the request, for which benefits may be recommended. Life events are ordinary events which occur in many people's lives, which can include:
Marriage/domestic partnership;
Divorce;
Onset of physical or mental illness;
Motor vehicle accident resulting in injury;
Retirement from a job;
Traveling;
Buying or selling a home;
A lifestyle change, such as starting martial arts training or a vegetarian diet.

An employee may have one or more life events occurring simultaneously; often the employee is not aware of the benefit and community resources available to him or her which may assist with these life event(s).

For example, referring to FIG. 1 and FIG. 4, a user 10 may find out that her husband has been diagnosed with late stage cancer, with only palliative treatment recommended. Obviously the user would be distraught about the diagnosis, with many worries, fears, and concerns. By utilizing the present invention, the user may determine what benefits (if any) the user and her husband have access to that can assist her with this traumatic and difficult life event, some of which she may be completely unaware of. For example, the user may utilize the present invention, and upon beginning use of the present invention be presented with the display shown in FIG. 4q. In FIG. 4q the user is utilizing a touch-screen smart phone, and in the present example would tap the “Health & Wellness” icon to further explore benefits relating to a cancer diagnosis. Upon tapping the Health & Wellness icon, the user would be presented with a new screen, showing more specific icons relating to Health & Wellness benefits. FIG. 1 shows an example of how such more specific icons may be categorized. For example, according to FIG. 1, the user may tap the following icons to learn more about:
Health Advocacy 14: The user may be experiencing stress regarding her husband's cancer diagnosis and some of the stress may be related to managing the insurance coverage for her husband's illness and his care coordination. A health advocacy program will assist her with managing these issues.
Legal 18: The user may have access to legal benefits, such as a free legal consultation to assist her in setting up her husband's will.
Wellness 16: The stress of a spouse's terminal cancer diagnosis may be wearing the user down physically, mentally, and emotionally. Exploring her wellness benefits may inform the user of information and programs that will help her make healthy nutrition and exercises choices to maintain her health.
Work/Life 20: After her husband passes away, the user may access may access the work/life benefit icon to learn about any benefits she may have that will assist her in making funeral arrangements.
Counseling 12: The user may have counseling benefits, such as access to a limited number of free counseling sessions to help her work through her grief and implement stress management techniques to help her through her husband's illness and death.

By utilizing the present invention as described above, the user may navigate from the broad life event of “cancer diagnosis,” through more specific benefits relevant and useful to a user who has or whose family member has been diagnosed with cancer.

### Explaining the Wheel of Life and Integrated Benefits Report

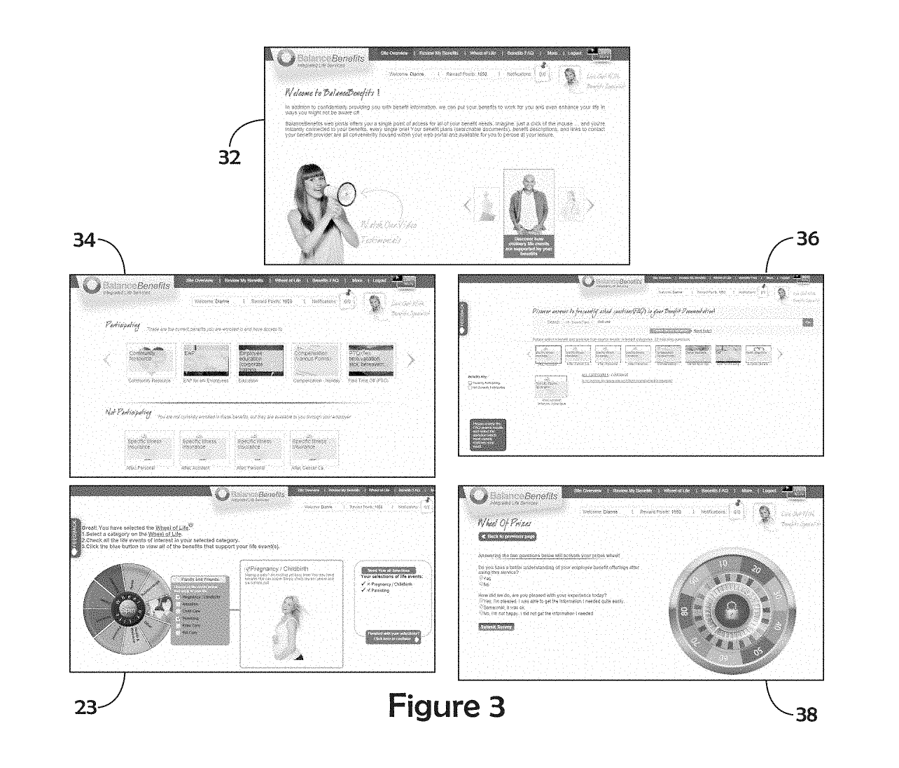

FIG. 3 is an example of a computer display of the screens a user may encounter when utilizing the present invention. The screens may include a member portal 32, which serves as a “welcome” screen that is common when logging on to websites or accessing software programs. From there, the user may navigate to a Review of My Benefits module 34, a Benefits FAQ module 36, and the Wheel of Life module 23. The Wheel of Life 23 module is merely another way to display the system claimed herein. Instead of the icons (which resemble “bubbles”) found in the display shown in FIG. 4q, the Wheel of Life 23 arranges categories of life events on a wheel graphic. When the system claimed herein is represented as a Wheel of Life 23 graphic, the user navigates the system the same way as described above—i.e., the user selects a life event displayed on the wheel; the user is then presented with categories of benefits relevant to the life event the user has selected; and the user may select a category of benefits to learn what benefits within that category are available to the user based on the user's employment and how to utilize such benefits.

The Benefits FAQ module 36, which may be included as part of the system claimed herein, provides answers to frequently asked questions (“FAQ”) and also provides links to appropriate documents in which the answer appears. This way, the employee may reference the source document immediately for more details.

The Wheel of Prizes module, which is an option that may be included in the present invention, 38 is used to provide incentives to employees using the member portal who are often not familiar with all benefits for which they qualify or who have not taken advantage thereof. The Wheel of Prizes module 38 offers the prizes from selected vendors to the employee after achieving certain point levels.

As any category on the Wheel of Life 23 is chosen by the employee or administrator clicking on it, the graphics displayed on the remainder of the screen can change in real time, thus guiding the employee along the appropriate path based on his or her selection of a life event.

Those with skill in the art will recognize that the “bubble icons” and Wheel of Life 23 graphic described herein are merely two of numerous methods by which the system claimed herein may be displayed and navigated. All such methods by which information regarding employment benefits may be categorized and navigated according to life events to which the benefits are relevant should be considered within the scope of the present invention. For example, benefits (and/or information about benefits) could be displayed as square icons, but the logistics of operating the system (i.e., selecting a life event and accessing information regarding benefits related to the life event) shall operate the same as described herein despite any difference in the way information is displayed (i.e., bubbles versus square). In addition, the present system may be utilized on any device that includes the necessary capabilities to permit the system claimed herein to function. For example, computers; smartphones; and tablets all may be used as a means to utilize the system claimed herein. The term “computer display,” as used herein, should be construed to include all such devices through which the system claimed herein is capable of operating.

FIGS. 4a through 4ii and 5a through 5dd are screen shots of a mobile application which connects users with their benefit information via the utilization of the technological system claimed herein.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

It should also be recognized that, in addition to presenting a user with information regarding benefits to which the user has access, the present system may also be used to provide a user with information regarding benefits that are relevant to particular life events but to which the employee does not have access. For example, the system claimed herein may be configured such that “Health and Wellness” life event presents a user with information regarding vision insurance, even though the user does not have access to vision insurance. By enabling the presentation of this information, a user may become educated about benefits to which the user may wish to pursue access, whether through the user's employment or independently.

Having thus described the invention, what is desired to be protected by Letters Patent is presented in the subsequently appended claims.

What is claimed is:

1. A technological system for counseling employees with regard to employment benefits, comprising:
a processor with an associated memory storage device and a computer display operatively connected thereto;
a database of information pertaining to employment benefits, with such information being stored in a memory storage device;
wherein such information pertaining to employment benefits is categorized according to life event categories, such that a user may select a life event category and by selecting such life event category be provided information about employment benefits that are available to the employee and related to such life event category.

2. The technological system claimed in claim 1, wherein such system is utilized via a computer.

3. The technological system claimed in claim 1, wherein such system is utilized via a smartphone.

4. The technological system claimed in claim 1, wherein such system is utilized via a tablet.

5. The technological system claimed in claim 1, wherein such system is utilized via a mobile application.

6. The technological system claimed in claim 1, wherein the life event categories are displayed as square icons.

7. The technological system claimed in claim 1, the life event categories are displayed to the user as bubble icons.

8. The technological system claimed in claim 1, the life event categories are displayed to the user on a wheel of life graphic.

9. The technological system claimed in claim 1, wherein said specified user can discover employment benefits to which the user does not have access by virtue of their employment.

10. The technological system claimed in claim 1, further comprising incentives for said specified user to use said system.
